(19) United States
(12) Patent Application Publication
(10) Pub. No.: US 2004/0244619 A1
(43) Pub. Date: Dec. 9, 2004

(54) Planographic printing plate precursor

(75) Inventor: Takahiro Goto, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/781,645

(22) Filed: Feb. 20, 2004

(30) Foreign Application Priority Data
Feb. 21, 2003 (JP) 2003-44093

(51) Int. Cl. B41N 1/00

(52) U.S. Cl. 101/453

(57) ABSTRACT

The present invention provides a planographic printing plate precursor suitable for direct printing using infrared laser light, comprising, on a substrate, a photosensitive layer containing an infrared absorbing agent, a sulfonium salt polymerization initiator, a polymerizable compound, and a binder polymer, wherein the central line average surface roughness (Ra) of the surface of the substrate on which the photosensitive layer is arranged is in the range of 0.35 to 0.55 μm.

### CROSS-REFERENCE TO RELATED APPLICATION

This application claims priority under 35 USC 119 from Japanese Patent Application No. 2003-44093, the disclosure of which is incorporated by reference herein.

### BACKGROUND OF THE INVENTION

1. Field of the Invention

The present invention relates to a negative type planographic printing plate precursor and, in particular, to a negative type planographic printing plate precursor capable of direct printing with an infrared laser light.

2. Description of the Related Art

Conventionally, presensitized plates (PS plates) having a lipophilic photosensitive resin layer provided on a hydrophilic substrate have been widely used as planographic printing plate precursors. Generally, the plate-making method includes exposing (i.e., surface exposure) a PS plate masked with a lithographic film, and having an image thereon, to light that passes through the lithographic film, followed by dissolving and removing the non-image areas.

In recent years, digital technologies involving electronic processing, and accumulation and output of image data utilizing computers have been spreading. A wide variety of new image output systems corresponding to these digital technologies has been brought into practical use. As a result, there has been a demand for computer-to-plate (CTP) techniques, whereby printing plates are produced directly by scanning highly directional light, such as laser light in accordance with digitized image information, without using lithographic film. It remains an important technical task to provide a planographic printing plate precursor that is suitable for these technologies.

Planographic printing plate precursors capable of being scan-exposed by light have been proposed and introduced to the market. In essence, such planographic printing plate precursors comprise a hydrophilic substrate provided with a lipophilic photosensitive resin layer (hereafter, referred to as the photosensitive layer) containing a photosensitive compound capable of generating active species, such as radicals or Bronsted acids, by exposure to laser light. The planographic printing plate precursor is subjected to laser scanning based on digital information in order to generate active species acting on the photosensitive layer to cause physical or chemical change, thus making the layer insoluble. The planographic printing plate precursor is then subjected to development processing, thereby producing a negative planographic printing plate.

In particular, planographic printing plate precursors having a photopolymerizable photosensitive layer containing a photopolymerization initiator with excellent photosensitivity, an addition-polymerizable ethylenically unsaturated compound, and a binder polymer soluble in an alkali developing solution, all arranged on a hydrophilic substrate, have been known. These planographic printing plate precursors have high productivity, can be subjected to simple development processing, and have excellent resolution and inking properties. These advantages provide the desired printing performance for planographic printing plate precursors.

Several substrates for use in the above-described planographic printing plate precursors have been known, including a substrate having a surface with a peeling strength of not higher than 500 g/cm, which is determined by peeling a press-contact gum tape from the surface (see, for example, Japanese Patent Application Laid-Open (JP-A) No. 2000-89455); and a substrate having a reflection density of 0.30 or higher (see, for example, JP-A No. 2002-283751).

In the above-described planographic printing plate precursor with the polymerizable photosensitive layer, the image forming property and image stability can deteriorate, depending on the substrate surface configuration or the degree of adhesiveness, which is affected by the surface configuration, between the substrate and the photosensitive layer. For example, depending on the surface roughness of the substrate, the substrate can be endowed with hydrophilicity and water-retaining property on the non-image portion. Nonetheless, when the surface is too rough, the thickness of the photosensitive layer is not formed uniformly, which can create areas where the energy of the exposure light cannot be efficiently utilized in the polymerization reaction. This in turn can make the strength of the image portion uneven or lower the adhesiveness to the photosensitive layer, thereby resulting in poor printing durability.

### SUMMARY OF THE INVENTION

In order to solve the problem in the related art as described above, an object of the present invention is to provide a planographic printing plate precursor having excellent sensitivity and printing durability and superior storability and, in particular, to provide a planographic printing plate precursor capable of direct printing using an infrared laser.

The present inventors made extensive study for achieving this object, and as a result, they found that the object can be achieved by regulating the surface configuration of a substrate, and the present invention was thereby made.

That is, the planographic printing plate precursor of the present invention comprises, on a substrate, a photosensitive layer containing an infrared absorbing agent, a sulfonium salt polymerization initiator, a polymerizable compound and a binder polymer, wherein the central line average surface roughness (Ra) of the surface of the substrate on which the photosensitive layer is arranged is in the range of 0.35 to 0.55 μm.

Preferably, the binder polymer in the planographic printing plate precursor of the present invention has a repeating unit represented by the following general formula (i):

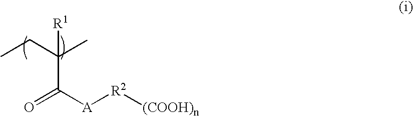

In general formula (i), R¹ represents a hydrogen atom or a methyl group; R² represents a linking group composed of two or more atoms selected from the group consisting of a carbon atom, a hydrogen atom, an oxygen atom, a nitrogen atom and a sulfur atom, wherein the total number of atoms in R² is 2 to 82; A represents an oxygen atom or —NR³—, wherein R³ represents a hydrogen atom or a monovalent hydrocarbon group having 1 to 10 carbon atoms; and n is an integer of 1 to 5.

The reaction mechanism of the present invention is not completely understood, but is presumed to function as follows:

In the planographic printing plate precursor of the present invention, the central line average surface roughness (Ra) of the surface of the substrate on which the photosensitive layer is arranged is defined in the above range, and thus, the adhesiveness of the substrate to the photosensitive layer can be improved, and the thickness of the photosensitive layer made to be uniform. Accordingly, uneven polymerization reactions in the photosensitive layer can be prevented, and the strength of an image portion can be uniform. In addition, a highly sensitive sulfonium salt polymerization initiator, which can efficiently absorb infrared laser light to generate radicals, is used in the photosensitive layer in the present invention, and therefore, radical polymerization reaction proceeds effectively to form a very strong image portion, thus improving both sensitivity and printing durability. There is also speculation that the adhesiveness between the substrate and the photosensitive layer is also improved, thus providing higher printing durability.

When the central line average surface roughness (Ra) of the substrate is too small, the density of bumps on the substrate becomes too high, thus reduction in developability causes the problem of a deterioration in raw stock storability. When the Ra is too high, problems attributed to unevenness of image areas arise; in the present invention, these problems hardly occur owing to the Ra defined in the above range. Accordingly, it would appear that the planographic printing plate precursor of the present invention has excellent sensitivity, printing durability, and raw stock storability.

When the binder polymer having a repeating unit, represented by the above general formula (i), is used in the photosensitive layer in the planographic printing plate precursor of the present invention, the binder polymer exhibits excellent dispersibility in a developing solution and responsiveness to alkali (solubility in an aqueous alkali solution). Accordingly, the photosensitive layer can be endowed with excellent solubility in a developing solution even if the acid content is very low (i.e., the acid value is insufficient). In the present planographic printing plate precursor, the photosensitive layer containing the binder polymer can thereby maintain high developability, while the photosensitive layer is not easily damaged by developer permeation caused by the acid content.

The sulfonium salt polymerization initiator contained in the photosensitive layer of the planographic printing plate precursor of the present invention is preferably a sulfonium salt represented by the following general formula (I):

General Formula (I)

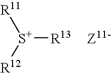

wherein R¹¹, R¹² and R¹³ may each be the same or different, and each represents a hydrocarbon group having 20 or less carbon atoms which may have at least one substituent group selected from the group consisting of a halogen atom, a nitro group, an alkyl group having 12 or less carbon atoms, an alkoxy group having 12 or less carbon atoms and an aryloxy group having 12 or less carbon atoms; and Z¹¹⁻ represents a counterion selected from the group consisting of a halogen ion, a perchlorate ion, a tetrafluoroborate ion, a hexafluorophosphate ion, a carboxylate ion, and a sulfonate ion.

The polymerizable compound used in the photosensitive layer of the planographic printing plate precursor of the present invention is an addition-polymerizable compound having at least one ethylenically unsaturated double bond, which is preferably selected from compounds having at least one ethylenically unsaturated double bond, and preferably two or more ethylenically unsaturated double bonds.

### BRIEF DESCRIPTION OF THE DRAWINGS

FIG. 1 is a schematic diagram showing a DRM interference wave-measuring instrument for measuring the behavior of dissolution of the photosensitive layer.

FIG. 2 is schematic diagram showing a method of measuring electrostatic capacity used in evaluating the degree of permeation of a developing solution into the photosensitive layer.

FIG. 3 is a side view showing the concept of a brush graining step used in mechanical surface roughening treatment in preparation of the planographic printing substrate in the present invention.

FIG. 4 is a graph showing one example of an alternating waveform electric current waveform used in electrochemical surface roughening treatment in preparation of the planographic printing substrate in the present invention.

FIG. 5 is a side view showing one example of a radical cell in electrochemical surface roughening treatment using an alternating current in preparation of the planographic printing substrate in the present invention.

FIG. 6 is a schematic drawing of an anodizing device used in anodizing treatment in preparation of the planographic printing substrate in the present invention.

### DETAILED DESCRIPTION OF THE INVENTION

Hereinafter, the planographic printing plate precursor of the present invention will be described in detail.

The planographic printing plate precursor of the present invention is a planographic printing plate precursor comprising a photosensitive layer containing an infrared absorbing agent, a sulfonium salt polymerization initiator, a polymerizable compound and a binder polymer on a substrate, wherein the central line average surface roughness (Ra) of the side of the substrate on which the photosensitive layer is arranged is in the range of 0.35 to 0.55 μm.

The planographic printing plate precursor of the present invention has a heat-polymerizable negative type photosensitive layer comprising an infrared absorbing agent, a sulfonium salt polymerization initiator, a polymerizable compound (also called an addition-polymerizable compound) and a binder polymer as essential components. The heat-polymerizable negative type photosensitive layer has a mechanism wherein the infrared absorbing agent absorbs an infrared laser light to convert the infrared light into heat, then the polymerization initiator is decomposed by this heat to generate radicals, and the polymerizable compound undergoes polymerization reaction by the generated radials. By prescribing the surface roughness of the substrate on which the photosensitive layer having such mechanism is provided, the resulting planographic printing plate precursor has an excellent sensitivity, printing durability and stability with time. The planographic printing plate precursor in the present invention is particularly preferably used in plate-making for direct printing by the use of an infrared laser light having a wavelength of 760 to 1,200 nm, to exhibit a higher printing durability and image-forming property than those of conventional planographic printing plate precursors.

First, the substrate for the planographic printing plate precursor of the present invention will be described in more detail.

<Substrate>

In the planographic printing plate precursor of the present invention, it is essential that the central line average surface roughness (Ra) of that side of the substrate on which the photosensitive layer is arranged is in the range of 0.35 to 0.55 μm. The central line average surface roughness (Ra) of the side of the substrate on which the photosensitive layer is arranged is more preferably in the range of 0.35 to 0.50 μm, and the central line average surface roughness (Ra) is still more preferably in the range of 0.40 to 0.50 μm. When the central line average surface roughness (Ra) of the side of the substrate on which the photosensitive layer is arranged is less than 0.35 μm, the density of bumps on the substrate is increased to reduce the developability of the photosensitive layer, and particularly, when polymerization reaction occurs during storage, a substrate having a lower Ra undergoes significant deterioration in developability, thus causing the problem of a reduction in stability with the passage of time. On the other hand, when the central line average surface roughness (Ra) is greater than 0.55 μm, the thickness of the photosensitive layer is so uneven that the polymerization reaction occurs unevenly thus making the strength of an image area uneven or deteriorating the adhesiveness of the substrate to the photosensitive layer, to cause the problem of a reduction in sensitivity and printing durability.

The substrate used in the present invention is preferably a dimensionally stable plate, and examples thereof include paper, paper laminated with plastics (e.g., polyethylene, polypropylene, polystyrene, etc.), a metal plate (e.g., aluminum, zinc, copper, etc.) and plastic film (e.g., cellulose diacetate, cellulose triacetate, cellulose propionate, cellulose butyrate, cellulose butyrate acetate, cellulose nitrate, polyethylene terephthalate, polyethylene, polystyrene, polypropylene, polycarbonate, polyvinyl acetal, etc.), and papers or plastic films having these metals laminated or vapor-deposited thereon. The surface of these substrates may be chemically or physically treated, if necessary, in order to imparting hydrophilicity thereto, or enhancing strength thereof.

Particularly, the substrate is preferably a paper, a polyester film or an aluminum plate, among which the aluminum plate is particularly preferable because it is excellent in dimensional stability, is relatively inexpensive, can provide a surface having excellent hydrophilicity and strength by surface treatment conducted as necessary. A composite sheet having an aluminum sheet bonded to a polyethylene terephthalate film, as described in JP-B No. 48-18327, is also preferable.

The aluminum plate is a metal plate based on dimensionally stable aluminum, and is selected not only from a pure aluminum plate but also from an alloy plate based on aluminum containing a very small amount of different elements and a plastic film or paper laminated or vapor-deposited with aluminum (alloy). In the following description, the substrates made of aluminum or aluminum alloys are referred to collectively as the aluminum substrate. The different elements contained in the aluminum alloy include silicon, iron, manganese, copper, magnesium, chromium, zinc, bismuth, nickel, titanium, etc. The content of the different elements in the alloy is up to 10% by mass. Particularly preferable aluminum in the present invention is a pure aluminum plate, but because production of absolutely pure aluminum by refining techniques is difficult, aluminum may contain a very small amount of different elements. The composition of the aluminum plate thus used in the present invention is not limited, and any aluminum plates made of a known and conventionally used aluminum material such as Japanese Industrial Standard (JIS) A 1050, JIS A 1100, JIS A 3103 and JIS A 3005 can be used as necessary.

The thickness of the aluminum plate is about 0.1 to 0.6 mm. This thickness can be suitably changed depending on the size of a printing machine, the size of a printing plate, and user's demands. The aluminum substrate is subjected to surface treatment described later to give the substrate in the present invention, wherein the central line average surface roughness (Ra) of the side of the substrate on which the photosensitive layer is arranged is in the range of 0.35 to 0.55 μm.

By suitably selecting and using a surface treatment method described below, a substrate whose central line average surface roughness (Ra) is in the range described above can be produced from a substrate made of a material other than aluminum.

Hereinafter, the means of controlling the central line average surface roughness (Ra) of the substrate in the present invention is described.

The method for controlling the central line average surface roughness (Ra) includes surface roughening treatment. An aluminum substrate is subjected to one or more treatments selected from mechanical surface roughening, chemical etching, electrolytic grinding treatment and electrochemical surface roughening, to control the surface configuration.

Hereinafter, examples of surface roughening treatment are described.

(Mechanical Surface Roughening)

In mechanical surface roughening treatment, the surface of an aluminum substrate can be mechanically roughened by a rotating nylon brush roll having a desired bristle diameter and slurry containing an abrasive fed onto the surface of the substrate. The abrasive may be a known material which is preferably borax, quartz, aluminum hydroxide or a mixture thereof. The treatment method is described in detail in JP-A No.6-135175 and Japanese Patent Application Publication (JP-B) No. 50-40047. In addition, a method of spraying slurry, a method of using a wire brush, and a method of transferring the surface configuration of an embossed calender roll onto the surface of a metallic substrate may be used. In particular, a method described in paragraph [0004] in JP-A No. 7-205565 can be used as a method of transferring a surface configuration. These mechanical surface roughening treatments can be used alone or in combination.

In order to control the central line average surface roughness (Ra) in the range of 0.35 to 0.55 μm by the mechanical surface roughening treatment, surface roughening conditions should be suitably regulated so as to be suited to the physical properties and surface configuration of a substrate before surface roughening treatment.

In the method of mechanical surface roughening, for example, by a nylon brush roll with slurry containing an abrasive, the central line average surface roughness (Ra) of the substrate can be controlled by regulating the diameter and length of bristle of the nylon brush roll or by regulating the diameter of the abrasive grain. Specifically, when the surface of the aluminum substrate is mechanically roughened by a nylon brush roll with slurry containing an abrasive, the diameter of bristle in the nylon brush roll is preferably in the range of 0.15 to 0.45 mm, and the average diameter of the abrasive grain is preferably in the range of 15 to 50 μm. When one of the two conditions is in the above range, the central line average surface roughness (Ra) can be controlled in the above-defined range, but preferably the central line average surface roughness (Ra) is controlled by regulating the average diameter of the abrasive grain, and more preferably the two conditions are preferably in the above ranges.

When mechanical surface roughening is followed by electrolytic grinding treatment or chemical etching treatment, the roughened surface of the substrate is changed by electrochemical surface roughening treatment, and thus the central line average surface roughness (Ra) is controlled preferably in consideration of this change.

(Electrolytic Grinding Treatment in an Aqueous Acidic Solution or Chemical Etching Treatment in an Aqueous Acid or Alkali Solution)

This treatment is carried out for the purpose of dissolving edges of bumps formed by the mechanical surface roughening, to give a highly stain-resistant printing plate having a smoothly undulating surface. The amount of the metallic substrate dissolved in this treatment is preferably in the range of 3 to 20 g/m².

The etching method may be carried out by dipping in an etching solution or spraying the solution. The etching agent is preferably sodium hydroxide, sodium carbonate, sodium aluminate, sodium metasilicate, sodium phosphate, potassium hydroxide, lithium hydroxide, etc., and the concentration and temperature of its solution are preferably in the range of 1 to 50% and 20 to 100° C., respectively.

After an electrolytic grinding treatment or chemical etching treatment is finished, the solution remaining on the surface is preferably removed with nip rollers and then washed away by spraying in order to prevent contamination in the subsequent step and to remove smuts remaining on the surface. In washing by spraying, acids such as nitric acid, sulfuric acid, phosphoric acid, chromic acid, hydrofluoric acid and hydroborofluoric acid are used.

(Electrochemical Surface Roughening Treatment With Direct or Alternating Current in an Aqueous Solution Containing Mainly Nitric Acid or Hydrochloric Acid)

This treatment is carried out for the purpose of forming crater- or honeycomb-shaped bits having an average diameter of about 0.5 to 20 μm on the surface of the metallic substrate at an area ratio of 30 to 100% of the surface. The treatment has an action of improving the printing durability of the resulting printing plate and the stain resistance of a non-image area thereof.

The quantity of electricity in anodizing suitable in this method is in the range of 50 to 400 C/dm². Specifically, alternating current and/or direct current electrolysis is conducted preferably at a temperature of 20 to 80° C., for 1 second to 30 minutes and at a current density of 100 to 400 C/dm² in an electrolytic solution containing 0.1 to 50% hydrochloric acid or nitric acid. The central line average surface roughness (Ra) of the substrate can also be controlled by regulating the quantity of electricity used in the electrochemical surface roughening treatment.

(Electrolytic Grinding Treatment in an Aqueous Acidic Solution or Chemical Etching Treatment in an Aqueous Acid or Alkali Solution)

This treatment is carried out for the purpose of removing smut components formed in the electrochemical surface roughening treatment while smoothing edges of formed bits, to give a printing plate having improved stain resistance. This treatment is carried out preferably by a method which involves contacting the substrate with 15 to 65% by mass sulfuric acid at a temperature of 50 to 90° C. as described in JP-A No. 53-12739 or a method of alkali etching as described in JP-B No. 48-28123. The amount of the substrate dissolved is preferably in the range of 0.05 to 5 g/m², more preferably in the range of 0.1 to 3 g/m².

The substrate (aluminum substrate) having a surface controlled in the predetermined central line average surface roughness (Ra) can be prepared in the manner described above. When the substrate in the present invention is made of a resin such as polyethylene terephthalate, the central line average surface roughness (Ra) thereof can be controlled by the mechanical surface roughening treatment or chemical etching described above. When the substrate thus prepared is used in a planographic printing plate precursor, the following anodizing treatment is preferably conducted.

(Anodizing Treatment)

In the anodizing treatment, an aqueous solution of sulfuric acid, phosphoric acid, oxalic acid or boric acid/sodium borate can be used as the major component in an electrolytic bath. In this case, the electrolytic solution may contain at least components usually contained in an Al alloy plate, electrode, tap water and underground water. Second and third components may also be contained. The second and third components include, for example, metal ions such as Na, K, Mg, Li, Ca, Ti, Al, V, Cr, Mn, Fe, Co, Ni, Cu and Zn, ammonium ions, and anions such as nitrate ion, carbonate ion, chlorine ion, phosphate ion, fluorine ion, sulfite ion, titanate ion, silicate ion and borate ion, and these may be contained at a concentration of 0 to 10000 ppm. Although the conditions for anodizing treatment are not particularly limited, the plate is treated preferably with 30 to 500 g/L solution at a temperature of 10 to 70° C. by direct current or alternating current electrolyte in the range of a current density of 0.1 to 40 A m². The thickness of the anodized layer formed is in the range of 0.5 to 1.5 μm. Preferably, the thickness is in the range of 0.5 to 1.0 μm. The treatment conditions should be selected such that the pore diameter of micropores present in the anodized layer formed on the substrate by the treatment described above is 5 to 10 nm and the pore density is 8×10¹⁵ to 2×10¹⁶ pores/m².

For treatment for hydrophlization of the surface of the substrate, various known methods can be used. The treatment is particularly preferably hydrophlization treatment with silicate or polyvinylphosphonic acid. The layer is formed from an Si or P element in an amount of 2 to 40 mg/m², preferably 4 to 30 mg/m². The coating amount can be determined by fluorescence X ray analysis.

In the hydrophilization treatment, the aluminum substrate having an anodized layer formed thereon is dipped in an aqueous solution at a pH value of 10 to 13 (determined at 25° C.) containing an alkali metal silicate or polyvinylphosphonic acid in an amount of 1 to 30% by mass, more preferably 2 to 15% by mass, for example at 15 to 80° C. for 0.5 to 120 seconds.

As the alkali metal silicate used in the hydrophilization treatment, sodium silicate, potassium silicate, lithium silicate, etc. are used. The hydroxide used for raising the pH value of the aqueous alkali metal silicate solution includes sodium hydroxide, potassium hydroxide, lithium hydroxide etc. Alkaline earth metal salts or the group IVB metal salts may be incorporated into the treatment solution described above. The alkaline earth metal salts include nitrates such as calcium nitrate, strontium nitrate, magnesium nitrate and barium nitrate, and water-soluble salts such as sulfate, hydrochloride, phosphate, acetate, oxalate and borate. The group IVB metal salts include titanium tetrachloride, titanium trichloride, titanium potassium fluoride, titanium potassium oxalate, titanium sulfate, titanium tetraiodide, zirconium chloride oxide, zirconium dioxide, zirconium oxychloride, zirconium tetrachloride, etc.

The alkaline earth metal salts or the group IVB metal salts can be used singly or in combination thereof. The amount of these metal salts is preferably in the range of 0.01 to 10% by mass, more preferably 0.05 to 5.0% by mass. Silicate electrodeposition as described in U.S. Pat. No. 3,658,662 is also effective. A substrate subjected to electrolytic grain as disclosed in JP-B No. 46-27481, JP-A No. 52-58602 and JP-A No. 52-30503, and surface treatment comprising the anodizing treatment in combination with the hydrophilization treatment, are also useful.

<Photosensitive Layer>

Now, the essential components constituting the photosensitive layer of the planographic printing plate precursor of the present invention, that is, an infrared absorbing agent, a sulfonium salt polymerization initiator, a polymerizable compound (also called an addition-polymerizable compound) and a binder polymer, and other arbitrary components will be described.

[Infrared Absorbing Agent]

It is generally essential that an infrared absorbing agent is used for a direct printing (image formation) process in which the planographic printing plate precursor of the present invention is exposed to a laser beam as a light source emitting an infrared light having a wavelength of 760 to 1,200 nm. The infrared absorbing agent has a function of converting the absorbed infrared light into heat. By this generated heat, a polymerization initiator (radical generating agent) described later is thermally decomposed to generate radicals. The infrared absorbing agent used in the present invention is preferably a dye or pigment having an absorption maximum at a wavelength in the range of 760 to 1,200 nm.

The dye may be any known commercially available dye including those described in publications such as Senryo Binran (Dye Handbook) (published in 1970 and compiled by the Society of Synthetic Organic Chemistry, Japan). Examples of such dyes include azo dyes, metal complex salt azo dyes, pyrazolone azo dyes, naphthoquinone dyes, anthraquinone dyes, phthalocyanine dyes, carbonium dyes, quinone imine dyes, methine dyes, cyanine dyes, squarylium dyes, pyrylium salts, and metal thiolate complexes. Preferable dyes include cyanine dyes such as those described in patent documents such as JP-A Nos. 58-125246, 59-84356, 59-202829, and 60-78787, and the methine dyes described in JP-A Nos. 58-173696, 58-181690, 58-194595, etc.. Further, the naphthoquinone dyes described in JP-A Nos. 58-112793, 58-224793, 59-48187, 59-73996, 60-52940, 60-63744, etc., the squarylium dyes described in JP-A No. 58-112792, etc., and the cyanine dyes described in Britsh Patent No. 434,875 are also preferably used.

The near infrared ray-absorbing sensitizers described in U.S. Pat. No. 5,156,938 are also preferably used. Also preferably used are the substituted aryl benzo(thio) pyrylium salts described in U.S. Pat. No. 3,881,924; the trimethine thiapyrylium salts described in JP-A No. 57-142645 (U.S. Pat. No. 4,327,169); the pyrylium type compounds described in JP-A Nos. 58-181051, 58-220143, 59-41363, 59-84248, 59-84249, 59-146063, and 59-146061; the cyanine dyes described in JP-A No. 59-216146; the pentamethine thiopyrylium salts described in U.S. Pat. No. 4,283,475; and the pyrylium compounds described in JP-B Nos. 5-13514 and 5-19702. Other preferable examples of dyes include the near infrared ray-absorbing dyes of formulae (I) and (II) described in U.S. Pat. No. 4,756,993.

Other preferable examples of the infrared absorbing dye in the present invention include specific indolenine cyanine dyes described in Japanese Patent Application Nos. 2001-6326 and 2001-237840, as shown below.

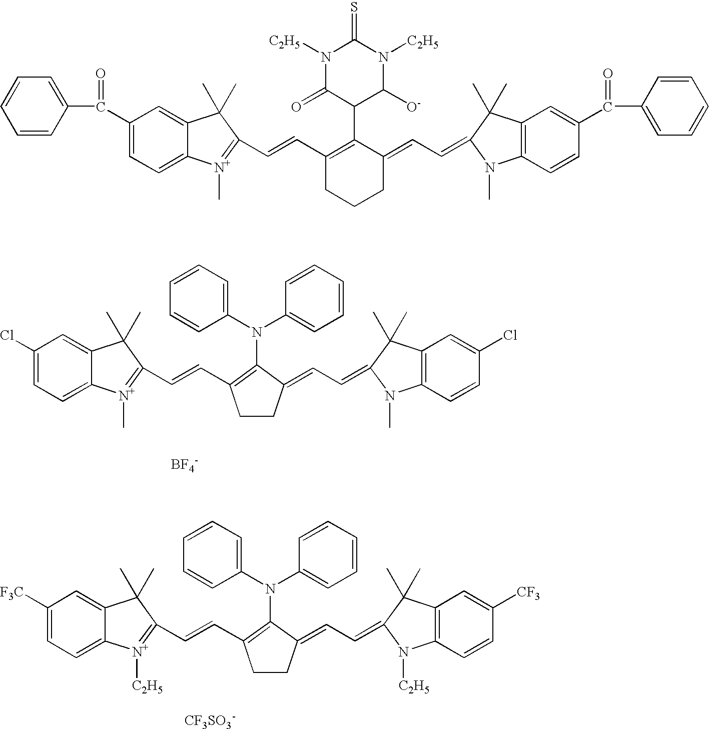

Particularly preferable among these dyes are cyanine dyes, squarylium dyes, pyrylium salts, nickel/thiolate complexes and indolenine cyanine dyes. The dyes are more preferably cyanine dyes and indolenine cyanine dyes, still more preferably cyanine dyes represented by general formula (a):

General Formula (a)

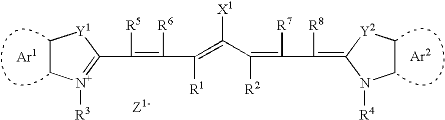

In the formula (a), X¹ represents a hydrogen atom, a halogen atom, —NPh₂, X²-L¹or a group shown below. X² represents an oxygen atom, a nitrogen atom or a sulfur atom, L¹ represents a hydrocarbon group having 1 to 12 carbon atoms, an aromatic ring having a heteroatom, and a hydrocarbon group having 1 to 12 carbon atoms containing a heteroatom. The heteroatom refers to N, S, O, a halogen atom or Se. Xa⁻ has the same meaning as that of Za⁻ defined later, and R^{a} represents a substituent group selected from a hydrogen atom, an alkyl group, an aryl group, a substituted or unsubstituted amino group, and a halogen atom.

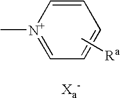

R¹ and R² each independently represents a hydrocarbon group having 1 to 12 carbon atoms. For the purpose of storability of the coating solution of the recording layer, each of R¹ and R² is preferably a hydrocarbon group having 2 or more carbon atoms, and more preferably R¹ and R² are linked to each other to form a 5- or 6-membered ring.

Ar¹ and Ar² may be the same or different and each represents an aromatic hydrocarbon group which may have a substituent group.

The aromatic hydrocarbon group is preferably a benzene ring or a naphthalene ring. The substituent group is preferably a hydrocarbon group having 12 or less carbon atoms, a halogen atom or an alkoxy group having 12 or less carbon atoms. Y¹ and Y² may be the same or different and each represents a sulfur atom or a dialkyl methylene group having 12 or less carbon atoms. R³ and R⁴ may be the same or different and each represents a hydrocarbon group containing 20 or less carbon atoms, which may have a substituent group. The substituent group is preferably an alkoxy group having 12 or less carbon atoms, a carboxyl group or a sulfo group. R⁵, R⁶, R⁷ and R⁸ may be the same or different and each represents a hydrogen atom or a hydrocarbon group having 12 or less carbon atoms. Each of R⁵, R⁶, R⁷ and R⁸ is preferably a hydrogen atom because the starting material is easily available. Za⁻ represents a counter anion. However, when the cyanine dye represented by the formula (a) has an anionic substituent group in its structure and does not necessitate neutralization of the charge, Za⁻ is not necessary. For the purpose of storability of the coating solution of the recording layer, Za⁻ is preferably a halogen ion, a perchlorate ion, a tetrafluoroborate ion, a hexafluorophosphate ion or a sulfonate ion, particularly preferably a perchlorate ion, a hexafluorophosphate ion or an aryl sulfonate ion.

Examples of the cyanine dyes represented by the formula (a), which can be preferably used in the present invention, include those described in paragraph [0017] to [0019] in JP-A No. 2001-133969.

Other preferable examples of the infrared absorbing agent in the present invention include specific indolenine cyanine dyes described in Japanese Patent Application Nos. 2001-6326 and 2001-237840 supra.

The pigments which can be used in the present invention include commercial pigments and those described in the Color Index (C. I.) Handbook, Saishin Ganryo Binran (Latest Dye Handbook) (published in 1977 and compiled by the Japanese Society of Pigment Technology); Saishin Ganryho Oyo Gijyutsu (Latest Pigment Applied Technology) (published in 1986 by CMC Publishing Co., Ltd.); and Insatsu Inki Gijyutsu (Printing Ink Technology) (published in 1984 by CMC Publishing Co., Ltd.). Examples include black pigments, yellow pigments, orange pigments, brown pigments, red pigments, violet pigments, blue pigments, green pigments, fluorescent pigments, metallic powder pigments, and other pigments such as polymer-binding dyes.

Specific examples of preferable pigments include insoluble azo pigments, azo lake pigments, condensed azo pigments, chelate azo pigments, phthalocyanine type pigments, anthraquinone type pigments, perylene and perinone type pigments, thioindigo type pigments, quinacridone type pigments, dioxazine type pigments, isoindolinone type pigments, quinophthalone type pigments, dyed lake pigments, azine pigments, nitroso pigments, nitro pigments, natural pigments, fluorescent pigments, inorganic pigments, and carbon black, which is preferable among these.

The pigments may or may not be subjected to surface treatment. Methods of surface treatment include coating the surface with resin or wax; allowing a surfactant to adhere to the surface; and adhering a reactive material (e.g., a silane coupling agent, an epoxy compound, a polyisocyanate, etc.) onto the surface of the pigment. These methods of surface treatment are described in Kinzoku Sekken No Seishitsu To Oyo (Properties and Application of Metallic Soap) (Sachi Shobo); Insatsu Inki Gijyutsu (Printing Ink Technology) (published in 1984 by CMC Publishing Co., Ltd.); and Saishin Ganryho Oyo Gijyutsu (Latest Pigment Applied Technology) (published in 1986 by CMC Publishing Co., Ltd.).

The particle diameters of the pigments are in the range of preferably 0.01 to 10 μm, more preferably 0.05 to 1 μm, and most preferably 0.1 to 1 μm. A pigment particle diameter of less than 0.01 μm is not preferable, since the stability of the pigment dispersion for a coating solution for the photosensitive layer (image forming layer) may deteriorate, whereas a particle diameter of more than 10 μm is not preferable since the uniformity of the photosensitive layer may deteriorate.

In the method of dispersing the pigment, known dispersing machines used widely in production of inks or toners and dispersing techniques can be suitably selected. Examples of suitable dispersing machines include a supersonic dispersing device, sand mill, attritor, pearl mill, super mill, ball mill, impeller, disperser, KD mill, colloid mill, dynatron, triple roll mill, press kneader, etc. These are described in detail in the aforementioned Saishin Ganryho Oyo Gijyutsu (Latest Newest Pigment Applied Technology) (published in 1986 by CMC Publishing Co., Ltd.).

The aforementioned infrared absorbing agents, along with other components, may be added to the same layer or to a separately provided layer such that in the resultant negative planographic printing precursor, the optical density of the photosensitive layer at the maximum absorption wavelength in the range of 760 to 1200 nm is in the range of 0.5 to 1.2 as determined by a reflection measurement method. The reflection optical density is preferably in the range of 0.6 to 1.15. When the optical density is outside of this range, the strength of an image portion is lowered to reduce the number of prints at the time of printing. The reason therefor is not evident, but is presumed that when the optical density is less than 0.5, the photosensitive layer cannot sufficiently absorb infrared rays, and as a result, the radical polymerization of the entire photosensitive layer does not sufficiently proceed, while when the optical density is higher than 1.2, only the outermost surface of the photosensitive layer absorbs infrared rays, and therefore the infrared rays do not reach a region near the substrate, and as a result, the radical polymerization does not occur in the vicinity of the substrate, thus resulting in insufficient adhesiveness of the photosensitive layer to the substrate.

The reflection optical density of the photosensitive layer can be controlled by the amount of the infrared absorbing agent added to the photosensitive layer and the thickness of the photosensitive layer. The optical density can be measured in a usual manner. The measurement method includes, for example, a method wherein the photosensitive layer whose thickness is determined suitably in a necessary range after drying for the planographic printing plate precursor is formed on a reflective substrate such as aluminum, and then measured for reflection density by an optical densitometer, or a method of measuring density with a spectrophotometer by a reflection method using an integrating sphere.

[Sulfonium Salt Polymerization Initiator]

The sulfonium salt polymerization initiator used in the photosensitive layer of the planographic printing plate precursor of the present invention is a thermally decomposable radical generating agent to be decomposed by heat to generate radicals, and has a function of initiating and promoting the curing reaction of the polymerizable compound described later. The sulfonium salt polymerization initiator is used in combination with the infrared absorbing agent described above to generate radicals by heat converted from infrared rays absorbed by the infrared absorbing agent upon irradiation with an infrared laser.

The sulfonium salt polymerization initiator used preferably in the present invention includes onium salts represented by the following general formula (I):

General Formula (I)

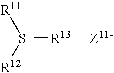

In the formula (I), R¹¹, R¹² and R¹³ may be the same or different and each represents an aryl group containing 20 or less carbon atoms, which may have a substituent group. The substituent group is preferably a halogen atom, a nitro group, an alkyl group having 12 or less carbon atoms, an alkoxy group having 12 or less carbon atoms, or an aryloxy group having 12 or less carbon atoms. Z¹¹⁻ represents a counterion selected from the group consisting of a halogen ion, a perchlorate ion, a tetrafluoroborate ion, a hexafluorophosphate ion, a carboxylate ion and a sulfonate ion, preferably a perchlorate ion, a hexafluorophosphate ion, a carboxylate ion and an aryl sulfonate ion.

Hereinafter, examples of the onium salts ([OS-1] to [OS-10]) represented by the general formula (I) are mentioned, but the onium salts are not limited thereto.

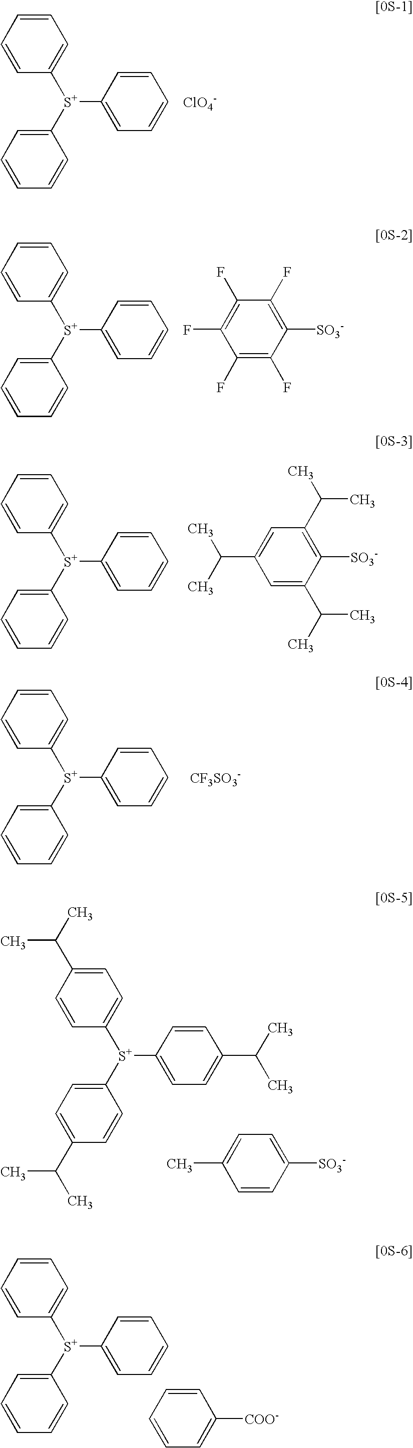

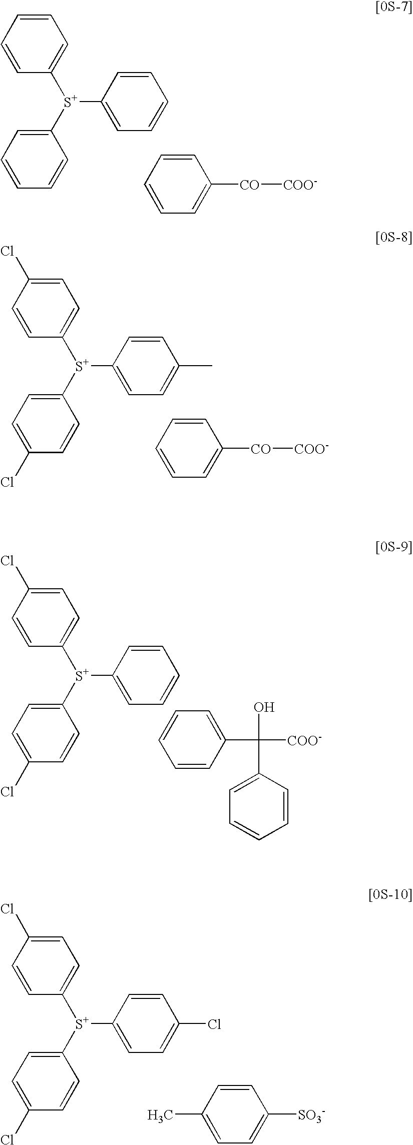

In addition to those described above, specific aromatic sulfonium salts described in JP-A Nos. 2002-148790, 2002-148790, 2002-350207 and 2002-6482 can also be preferably used.

In the present invention, other polymerization initiators (other radical generating agents) can be used in combination with the sulfonium salt polymerization initiator contained as an essential component.

The other radical generating agents include onium salts (excluding sulfonium salts), triazine compounds having a trihalomethyl group, peroxides, azo-type polymerization initiators, azide compounds, quinone diazide, oxime ester compounds and triaryl monoalkyl borate compounds. Among these compounds, the onium salts are highly sensitive and preferably used.

Examples of the onium salts which can be used preferably in the present invention include iodonium salts and diazonium salts. In the present invention, these onium salts function not as acid generating agents but as radical polymerization initiators.

The iodonium salt and diazonium salt used in the present invention include iodonium salts and diazonium salts represented by the following general formulae (II) and (III) respectively:

Ar²¹-I⁺-Ar²²Z²¹⁻ General formula (II)

Ar³¹-N⁺≡N Z³¹⁻ General formula (III)

In the general formula (II), Ar²¹ and Ar²² each independently represents an aryl group containing 20 or less carbon atoms, which may have a substituent group. When this aryl group has a substituent group, the substituent group is preferably a halogen atom, a nitro group, an alkyl group having 12 or less carbon atoms, an alkoxy group having 12 or less carbon atoms, or an aryloxy group having 12 or less carbon atoms. Z²¹⁻ represents a counterion having the same meaning as defined for Z¹¹⁻.

In the general formula (III) , Ar³¹ represents an aryl group having 20 or less carbon atoms, which may have a substituent group. The substituent group is preferably a halogen atom, a nitro group, an alkyl group having 12 or less carbon atoms, an alkoxy group having 12 or less carbon atoms, an aryloxy group having 12 or less carbon atoms, an alkylamino group having 12 or less carbon atoms, a dialkylamino group having 12 or less carbon atoms, an arylamino group having 12 or less carbon atoms, or a diarylamino group having 12 or less carbon atoms. Z³¹⁻ represents a counterion having the same meaning as defined for Z¹¹⁻.

Preferable examples of the iodonium salts ([OI-1] to [OI-10]) represented by the general formula (II) and the diazonium salts ([ON-1] to [ON-5]) represented by the general formula (III) are mentioned below, but the salts are not limited thereto.

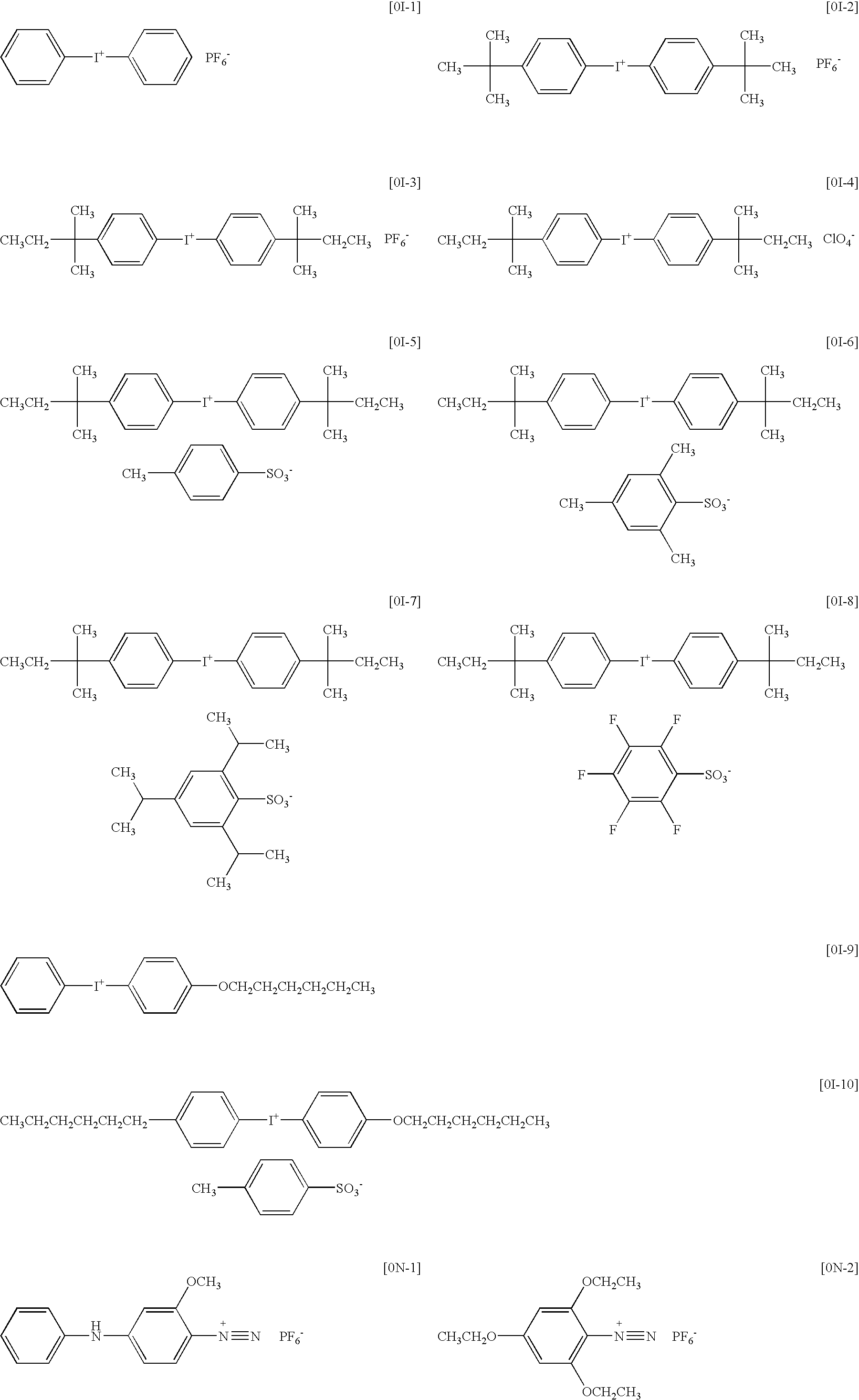

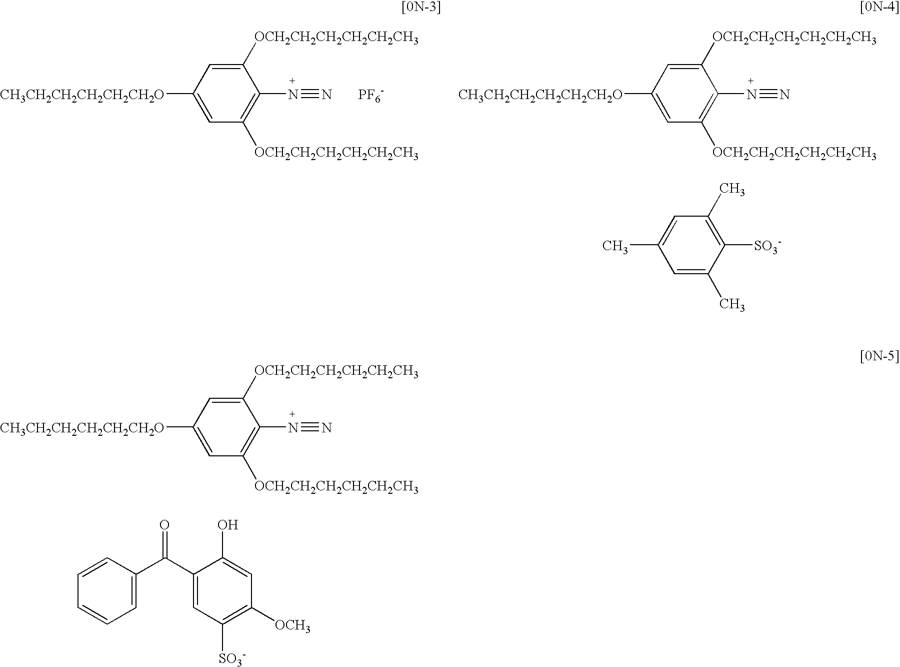

In the present invention, examples of the onium salts preferably used as the polymerization initiator (radical generating agent) in the present invention include those described in JP-A No. 2001-133696.

The polymerization initiator (radical-generating agent) used in the present invention has a maximum absorption wavelength of preferably 400 nm or less, more preferably 360 nm or less. By using the radical-generating agent having its absorption wavelength in the UV range, the planographic printing plate precursor can be handled under an incandescent lamp.

The total content of the polymerization initiators in the present invention is 0.1 to 50% by mass, preferably 0.5 to 30% by mass, more preferably 1 to 20% by mass, based on the solids content of the photosensitive layer. When the amount of the polymerization initiators added is less than 0.1% by mass, the sensitivity is lowered, while when the amount is higher than 50% by mass, non-image areas may be easily tinted in printing.

In the present invention, only one polymerization initiator or two or more polymerization initiators may be used insofar as a sulfonium salt polymerization initiator is contained as the essential component. When two or more polymerization initiators are used in combination, a plurality of sulfonium salt polymerization initiators can be used, or the sulfonium salt polymerization initiator can be used in combination with another polymerization initiator.

When the sulfonium salt polymerization initiator is used in combination with another polymerization initiator, the ratio (ratio by mass) of the sulfonium salt polymerization initiator to the other polymerization initiator is preferably 100/1 to 100/50, more preferably 100/5 to 100/25.

The polymerization initiator, along with other components, may be added to the same layer or to a separately provided layer.

According to the present invention, the highly sensitive sulfonium salt polymerization initiator is contained in the photosensitive layer so that radical polymerization reaction proceeds effectively to significantly increase the strength of image areas formed. In an embodiment wherein the planographic printing plate precursor of the present invention has a protective layer on the photosensitive layer, a planographic printing plate having high-strength image areas in cooperation with the oxygen impermeability function of the protective layer can be produced, and as a result, printing durability is improved. The sulfonium salt polymerization initiator has an excellent storability with the lapse of time and can thus prevent occurrence of undesired polymerization reaction in the produced planographic printing plate precursor during storage.

[Polymerizable Compound]

The polymerizable compound used in the photosensitive layer of the planographic printing plate precursor of the invention is an addition-polymerizable compound having at least one ethylenically unsaturated double bond, and is selected from compounds each having at least one (preferably two or more) ethylenically unsaturated bond. A group of such compounds is known widely in this industrial field, and in the present invention, these compounds can be used without any particular limitation. These compounds occur in chemical forms such as monomers, prepolymers, that is, dimers, trimers and oligomers, as well as mixtures thereof and copolymers thereof. Examples of such monomers and copolymers include unsaturated carboxylic acids (e.g., acrylic acid, methacrylic acid, itaconic acid, crotonic acid, isocrotonic acid, maleic acid, etc.) and esters and amides thereof, and preferably used among these compounds are esters between unsaturated carboxylic acids and aliphatic polyvalent alcohols and amides between unsaturated carboxylic acids and aliphatic polyvalent amines. Also preferably used among these compounds are unsaturated carboxylates having nucleophilic substituent groups such as hydroxyl group, amino group, mercapto group, etc., addition-reaction products of amides with monofunctional or multifunctional isocyanates or epoxy compounds, and dehydration condensation reaction products of amides with monofunctional or multifunctional carboxylic acids. Also preferably used among these compounds are unsaturated carboxylates having electrophilic substituent groups such as isocyanate group, epoxy group, etc., addition-reaction products of amides with monofunctional or multifunctional alcohols, amines or thiols, unsaturated carboxylates having releasing substituent groups such as halogen group, tosyloxy group, etc., and substitution-reaction products of amides with monofunctional or multifunctional alcohols, amines or thiols. A group of those compounds wherein the above-described unsaturated carboxylic acids are replaced by unsaturated phosphonic acid, styrene, vinyl ethers, etc, can also be used.

As the ester monomers between aliphatic polyvalent alcohols and unsaturated carboxylic acids, the acrylates include ethylene glycol diacrylate, triethylene glycol diacrylate, 1,3-butane diol diacrylate, tetramethylene glycol diacrylate, propylene glycol diacrylate, neopentyl glycol diacrylate, trimethylol propane triacrylate, trimethylol propane tri(acryloyloxypropyl)ether, trimethylol ethane triacrylate, hexane diol diacrylate, 1,4-cyclohexane diol diacrylate, tetraethylene glycol diacrylate, pentaerythritol diacrylate, pentaerythritol triacrylate, pentaerythritol tetracrylate, dipentaerythritol diacrylate, dipentaerythritol hexacrylate, sorbitol triacrylate, sorbitol tetracrylate, sorbitol pentacrylate, sorbitol hexacrylate, tri(acryloyloxyethyl) isocyanurate, polyester acrylate oligomers, etc.

The methacrylates include tetramethylene glycol dimethacrylate, triethylene glycol dimethacrylate, neopentyl glycol dimethacrylate, trimethylol propane trimethacrylate, trimethylol ethane trimethacrylate, ethylene glycol dimethacrylate, 1,3-butane diol dimethacrylate, hexane diol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethyl methane, bis[p-(methacryloxyethoxy)phenyl]dimethyl methane, etc.

The itaconates include ethylene glycol diitaconate, propylene glycol diitaconate, 1,3-butane diol diitaconate, 1,4-butane diol diitaconate, tetramethylene glycol diitaconate, pentaerythritol diitaconate, sorbitol tetraitaconate, etc.

The crotonates include ethylene glycol dicrotonate, tetramethylene glycol dicrotonate, pentaerythritol dicrotonate, sorbitol tetradicrotonate, etc.

The isocrotonates include ethylene glycol diisocrotonate, pentaerythritol diisocrotonate, sorbitol tetraisocrotonate, etc.

The maleates include ethylene glycol dimaleate, triethylene glycol dimaleate, pentaerythritol dimaleate, sorbitol tetramaleate, etc.

Other preferably used esters include, for example, aliphatic alcohol-based esters described in Japanese Patent Application Publication (JP-B) Nos. 46-27926, 51-47334 and Japanese Patent Application Laid-Open (JP-A) No. 57-196231, those having an aromatic skeleton described in JP-A Nos. 59-5240, 59-5241 and 2-226149, and those having an amino group described in JP-A No. 1-165613. The ester monomers can also be used as a mixture.

The amide monomers between aliphatic polyvalent amines and unsaturated carboxylic acids include, for example, methylene bis-acrylamide, methylene bis-methacrylamide, 1,6-hexamethylene bis-acrylamide, 1,6-hexamethylene bis-methacrylamide, diethylene triamine trisacrylamide, xylylene bisacrylamide, xylylene bismethacrylamide, etc. Preferable examples of other amide type monomers include those having a cyclohexylene structure described in JP-B No. 54-21726.

Urethane type addition-polymerizable compounds produced by addition reaction between isocyanates and hydroxyl groups are also preferable, and examples thereof include vinyl urethane compounds containing two or more polymerizable vinyl groups in one molecule, which are prepared by adding vinyl monomers containing a hydroxyl group represented by the general formula (1) below to polyisocyanates having two or more isocyanate groups in one molecule as described in JP-B No. 48-41708.

CH₂═C(R₄)COOCH₂CH(R₅)OH (1)

wherein R₄ and R₅ each independently represents H or CH₃.

Urethane acrylates described in JP-A No. 51-37193, JP-B Nos. 2-32293 and 2-16765 and urethane compounds having an ethylene oxide-type skeleton described in JP-B Nos. 58-49860, 56-17654, 62-39417 and 62-39418 are also preferable. Addition-polymerizable compounds having an amino structure or sulfide structure in the molecule as described in JP-A Nos. 63-277653, 63-260909 and 1-105238 can be used to prepare photopolymerizable compositions having extremely excellent photosensitizing speed.

As other examples, multifunctional acrylates and methacrylates such as polyester acrylates and epoxy acrylates obtained by reacting epoxy resin with (meth)acrylic acid as described in JP-A No. 48-64183, JP-B Nos. 49-43191 and 52-30490 can be exemplified. Specific unsaturated compounds described in JP-B Nos. 46-43946, 1-40337 and 1-40336 and vinyl phosphonic acid-type compounds described in JP-A No. 2-25493 can also be exemplified. In some cases, a structure containing a perfluoroalkyl group described in JP-A No. 61-22048 is preferably used. Photo-curable monomers and oligomers described in the Journal of Japanese Adhesive Society, vol. 20, No. 7, pp.300-308 (1984) can also be used.

Details of method of using these addition-polymerizable compounds, for example, the structure thereof, single use or use in combination thereof, and the amount to be used, can be arbitrarily determined depending on the performance and design of the final planographic printing plate precursor. For example, they are selected from the following viewpoints. From the viewpoint of photosensitizing speed, the addition-polymerizable compounds preferably have many unsaturated groups in one molecule, and in many cases, they are preferably bifunctional or more. In order to increase the strength of image areas, i.e. a cured layer, the addition-polymerizable compounds are preferably trifunctional or more. It is also effective to use a method of regulating both photosensitivity and strength by combined use of compounds (e.g. acrylates, methacrylates, styrene type compounds, and vinyl ether type compounds) having different functionalities and different polymerizable groups. The high-molecular compounds or highly hydrophobic compounds, though these compounds have excellent photosensitizing speed and film strength, may be undesirable in some cases in respect of developing speed and precipitation in the developing solution. The method of selecting and using the addition-polymerizable compound is an important factor for compatibility with other components (e.g. a binder polymer, an initiator, a coloring agent etc.) and dispersibility in the photosensitive layer, and the compatibility may be improved by using, e.g. a low-purity compound or a combination of two or more compounds. A specific structure can be selected for the purpose of improving adhesiveness of the photosensitive layer to a substrate, an overcoat layer, etc. described later. The ratio of the addition-polymerizable compound blended in the photosensitive layer is advantageously higher for sensitivity, but a too high ratio causes undesirable phase separation, problems in the production process caused by the stickiness of the photosensitive layer (e.g., product defects caused by transfer and adhesion of components in the photosensitive layer), and precipitation from the developing solution. From these viewpoints, the addition-polymerizable compounds are used in the range of preferably 5 to 80% by mass, more preferably 25 to 75% by mass, based on nonvolatile components in the photosensitive layer. These compounds may be used singly or in combination thereof. From the viewpoints of the degree of inhibition of polymerization by oxygen, resolution, fogging property, a change in refractive index and surface stickiness, a suitable chemical structure, compounding and amount thereof can be arbitrarily selected in the method of using the addition-polymerizable compound, and a layer structure and a coating method such as an undercoat and overcoat can also be carried out as necessary.

(Binder Polymer)

From the viewpoint of improving layer-forming properties, the photosensitive layer in the present invention preferably comprises a binder polymer, which can be any type of polymers as long as they have functions to enhancing layer-forming properties. Particularly, a binder polymer has preferably a repeating unit represented by formula (i) (also referred to as the specific binder polymer):

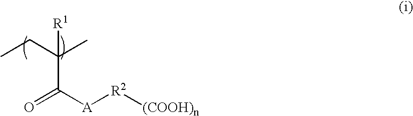

wherein, R¹ represents a hydrogen atom or a methyl group; R² represents a linking group composed of two or more atoms selected from the group consisting of a carbon atom, a hydrogen atom, an oxygen atom, a nitrogen atom and a sulfur atom, wherein the total number of atoms in R² is 2 to 82; A represents an oxygen atom or —NR³—, wherein R³ represents a hydrogen atom or a monovalent hydrocarbon group having 1 to 10 carbon atoms; and n is an integer of 1 to 5.

R¹ in the general formula (i) represents a hydrogen atom or a methyl group, preferably a methyl group. The linking group represented by R² in the general formula (i) is a linking group composed of two or more atoms selected from the group consisting of a carbon atom, a hydrogen atom, an oxygen atom, a nitrogen atom and a sulfur atom, wherein the number of atoms is 2 to 82, preferably 2 to 50, more preferably 2 to 30. The number of atoms refers to the number of atoms including atoms in a substituent group, if any, on the linking group.

Specifically, the number of carbon atoms in the main skeleton of the linking group represented by R² is preferably 1 to 30, more preferably 3 to 25, still more preferably 4 to 20, most preferably 5 to 10. The “main skeleton of the linking group” in the present invention refers to an atom or an atomic group used in linking A to the terminal COOH in the general formula (i), and when a plurality of linkages are present, the main skeleton refers to an atom or an atomic group constituting a linkage having the smallest number of atoms. Accordingly, when the linking group has a cyclic structure, its linking sites (for example, o-, m-, p- etc.) are different in the number of atoms to be introduced into them.

The linking group represented by R² is more specifically alkylene, substituted alkylene, arylene and substituted arylene, and a plurality of these divalent groups may be linked to one another via amide or ester linkages.

Linking groups having a chain structure include ethylene and propylene groups. These alkylene groups may be linked to each other through an ester linkage.

The linking group represented by R² in formula (i) is preferably a (n+1)-valent hydrocarbon group having an alicyclic structure having 3 to 30 carbon atoms. Examples thereof include (n+1)-valent hydrocarbon groups obtained by removing (n+1) hydrogen atoms on arbitrary carbon atoms constituting compounds having an alicyclic structure, such as cyclopropane, cyclopentane, cyclohexane, cycloheptane, cyclooctane, cyclodecane, dicyclohexyl, tertiary cyclohexyl and norbornane which may be substituted with one or more arbitrary substituent groups. R² is preferably the one containing 3 to 30 carbon atoms including carbon atoms in a substituent group if any.

The arbitrary carbon atoms in a compound constituting an alicyclic structure may be substituted with one or more heteroatoms selected from the group consisting of a nitrogen atom, an oxygen atom and a sulfur atom. In terms of printing durability, R² is preferably a (n+1)-valent hydrocarbon group having an alicyclic structure which may have a substituent group having 5 to 30 carbon atoms comprising two or more rings, such as a condensed polycyclic aliphatic hydrocarbon, a crosslinked alicyclic hydrocarbon, spiroaliphatic hydrocarbon, and combined aliphatic hydrocarbon rings (plural rings combined directly or via linking groups). The number of carbon atoms refers to the number of carbon atoms including carbon atoms in a substituent group, if any.

The linking group represented by R² is preferably a group containing 5 to 10 atoms, having a cyclic structure containing an ester linkage or the cyclic structure described above.

A substituent group which can be introduced into the linking group represented by R² includes a monovalent non-metal atomic group excluding hydrogen, and examples thereof include a halogen atom (—F, —Br, —Cl, —I), hydroxyl group, alkoxy group, aryloxy group, mercapto group, alkyl thio group, aryl thio group, alkyl dithio group, aryl dithio group, amino group, N-alkyl amino group, N,N-dialkyl amino group, N-aryl amino group, N,N-diaryl amino group, N-alkyl-N-aryl amino group, acyloxy group, carbamoyloxy group, N-alkylcarbamoyloxy group, N-aryl carbamoyloxy group, N,N-dialkyl carbamoyloxy group, N,N-diaryl carbamoyloxy group, N-alkyl-N-aryl carbamoyloxy group, alkyl sulfoxy group, aryl sulfoxy group, acyl thio group, acyl amino group, N-alkyl acyl amino group, N-aryl acyl amino group, ureido group, N′-alkylureido group, N′,N′-dialkylureido group, N′-aryl ureido group, N′,N′-diaryl ureido group, N′-alkyl-N′-aryl ureido group, N-alkyl ureido group, N-aryl ureido group, N′-alkyl-N-alkyl ureido group, N′-alkyl-N-aryl ureido group, N′,N′-dialkyl-N-alkyl ureido group, N′,N′-dialkyl-N-aryl ureido group, N′-aryl-N-alkyl ureido group, N′-aryl-N-aryl ureido group, N′,N′-diaryl-N-alkyl ureido group, N′,N′-diaryl-N-aryl ureido group, N′-alkyl-N′-aryl-N-alkyl ureido group, N′-alkyl-N′-aryl-N-aryl ureido group, alkoxy carbonyl amino group, aryloxy carbonyl amino group, N-alkyl-N-alkoxycarbonyl amino group, N-alkyl-N-aryloxy carbonyl amino group, N-aryl-N-alkoxycarbonyl amino group, N-aryl-N-aryloxycarbonyl amino group, formyl group, acyl group, carboxyl group and its conjugated basic group, alkoxy carbonyl group, aryloxy carbonyl group, carbamoyl group, N-alkyl carbamoyl group, N,N-dialkyl carbamoyl group, N-aryl carbamoyl group, N,N-diaryl carbamoyl group, N-alkyl-N-aryl carbamoyl group, alkyl sulfinyl group, aryl sulfinyl group, alkyl sulfonyl group, aryl sulfonyl group, sulfo group (—SO₃H) and its conjugated basic group, alkoxy sulfonyl group, aryloxy sulfonyl group, sulfinamoyl group, N-alkyl sulfinamoyl group, N,N-dialkyl sulfinamoyl group, N-aryl sulfinamoyl group, N,N-diaryl sulfinamoyl group, N-alkyl-N-aryl sulfinamoyl group, sulfamoyl group, N-alkyl sulfamoyl group, N,N-dialkyl sulfamoyl group, N-aryl sulfamoyl group, N,N-diaryl sulfamoyl group, N-alkyl-N-aryl sulfamoyl group, N-acyl sulfamoyl group and its conjugated basic group, N-alkyl sulfonyl sulfamoyl group (—SO₂NHSO₂ (alkyl)) and its conjugated basic group, N-aryl sulfonyl sulfamoyl group (—SO₂NHSO₂(aryl)) and its conjugated basic group, N-alkyl sulfonyl carbamoyl group (—CONHSO₂(alkyl)) and its conjugated basic group, N-aryl sulfonyl carbamoyl group (—CONHSO₂(aryl)) and its conjugated basic group, alkoxy silyl group (—Si(O-alkyl)₃), aryloxy silyl group (—Si(O-aryl)₃), hydroxylyl group (—Si(OH)₃) and its conjugated basic group, pohsphono group (—PO₃H₂) and its conjugated basic group, dialkyl phosphono group (—PO₃(alkyl)₂), diaryl phosphono group (—PO₃(aryl)₂) alkyl aryl phosphono group (—PO₃ (alkyl) (aryl)), monoalkyl phosphono group (—PO₃H(alkyl)) and its conjugated basic group, monoaryl phosphono group (—PO₃H(aryl)) and its conjugated basic group, phosphonoxy group (—OPO₃H₂) and its conjugated basic group, dialkyl phosphonoxy group (—OPO₃(alkyl)₂), diaryl phosphonoxy group (—OPO₃(aryl)₂), alkyl aryl phosphonoxy group (—OPO₃(alkyl)(aryl)), monoalkyl phosphonoxy group (—OPO₃H(alkyl)) and its conjugated basic group, monoaryl phosphonoxy group (—OPO₃H(aryl)) and its conjugated basic group, cyano group, nitro group, dialkyl boryl group (—B(alkyl)₂), diaryl boryl group (—B(aryl)₂), alkyl aryl boryl group (—B (alkyl) (aryl)), dihydroxy boryl group (—B(OH)₂) and its conjugated basic group, alkyl hydroxy boryl group (—B(alkyl)(OH)) and its conjugated basic group, aryl hydroxy boryl group (—B(aryl)(OH)) and its conjugated basic group, aryl group, alkenyl group and alkynyl group.

Depending on the design of the photosensitive layer, a substituent group having a hydrogen atom capable of hydrogen bonding, particularly a substituent group having acidity whose acid dissociation constant (pKa) is lower than that of carboxylic acid, is not preferable because it tends to deteriorate printing durability. On the other hand, a hydrophobic substituent group such as a halogen atom, a hydrocarbon group (alkyl group, aryl group, alkenyl group, alkynyl group), an alkoxy group and an aryloxy group is preferable because it tends to improve printing durability, and particularly when the cyclic structure is a 6- or less memberred monocyclic aliphatic hydrocarbon such as cyclopentane or cyclohexane, the hydrocarbon preferably has such hydrophobic substituent groups. If possible, these substituent groups may be bound to one another or to a substituted hydrocarbon group to form a ring, and the substituent groups may further be substituted.

When A in formula (i) is NR³—, R³ represents a hydrogen atom or a monovalent hydrocarbon group having 1 to 10 carbon atoms. The monovalent hydrocarbon group having 1 to 10 carbon atoms represented by R³ includes an alkyl group, aryl group, alkenyl group and alkynyl group.

Examples of the alkyl group having 1 to 10 carbon atoms include a linear, branched or cyclic alkyl group such as a methyl group, ethyl group, propyl group, butyl group, pentyl group, hexyl group, heptyl group, octyl group, nonyl group, decyl group, isopropyl group, isobutyl group, sec-butyl group, tert-butyl group, isopentyl group, neopentyl group, 1-methylbutyl group, isohexyl group, 2-ethylhexyl group, 2-methylhexyl group, cyclopentyl group, cyclohexyl group, 1-adamanthyl group and 2-norbornyl group.

Examples of the aryl group having 1 to 10 carbon atoms include an aryl group such as a phenyl group, naphthyl group and indenyl group, a heteroaryl group having 1 to 10 carbon atoms containing one heteroatom selected from the group consisting of a nitrogen atom, an oxygen atom and a sulfur atom, for example a furyl group, thienyl group, pyrrolyl group, pyridyl group and quinolyl group.

Examples of the alkenyl group having 1 to 10 carbon atoms include a linear, branched or cyclic alkenyl group such as a vinyl group, 1-propenyl group, 1-butenyl group, 1-methyl-1-propenyl group, 1-cyclopentenyl group and 1-cyclohexenyl group.

Examples of the alkynyl group include an alkynyl group having 1 to 10 carbon atoms such as an ethynyl group, 1-propynyl group, 1-butynyl group and 1-octynyl group. Substituent groups which may be possessed by R³ include the same substituent groups as those capable of being introduced into R². The number of carbon atoms in R³, including the number of carbon atoms in its substituent group, is 1 to 10.

A in the formula (i) is preferably an oxygen atom or —NH— because of easy synthesis.

n in the formula (i) is an integer of 1 to 5, preferably 1 in view of printing durability.

Preferable examples of the repeating unit represented by the formula (i) in the specific binder polymer are shown below, but the present invention is not limited thereto.

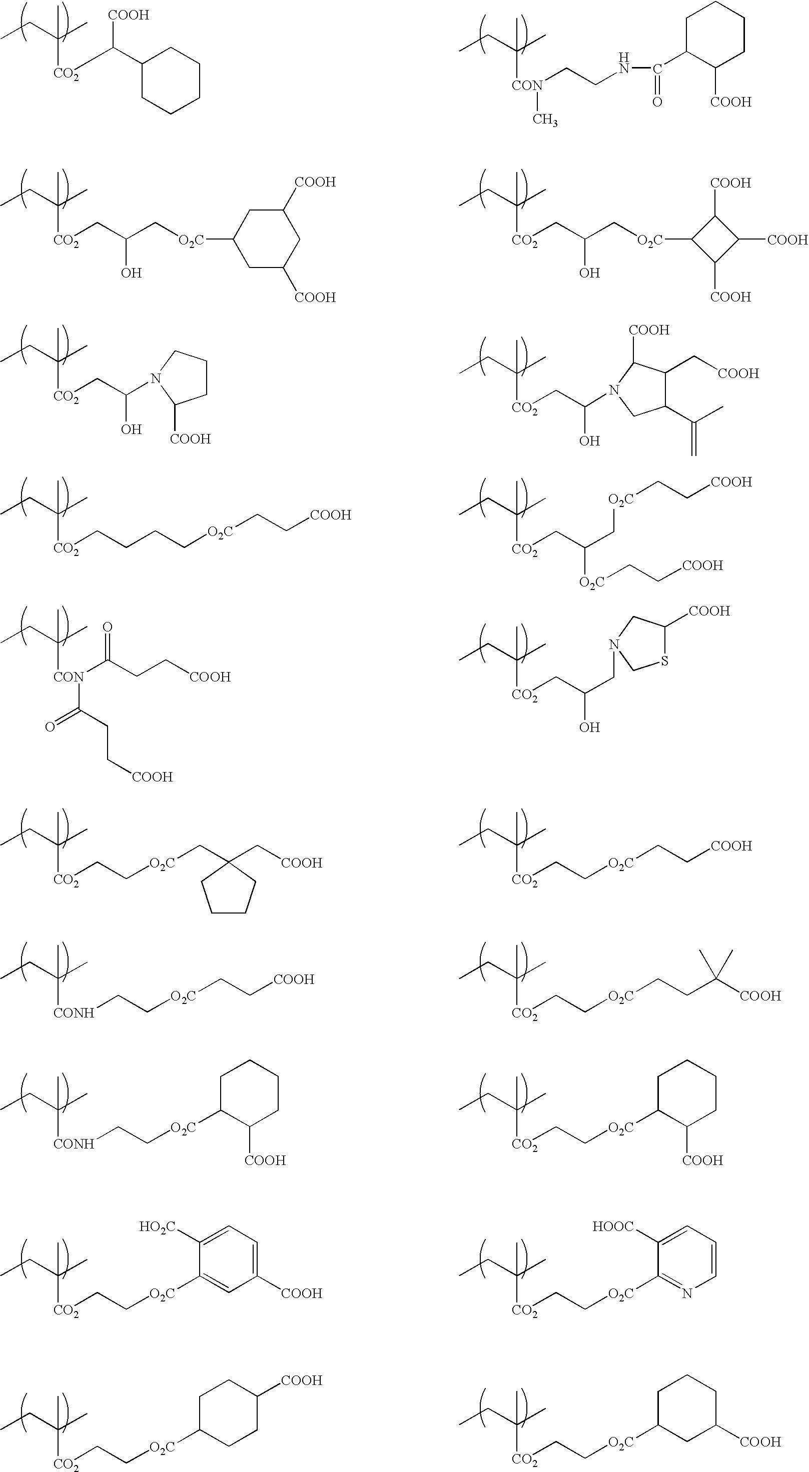

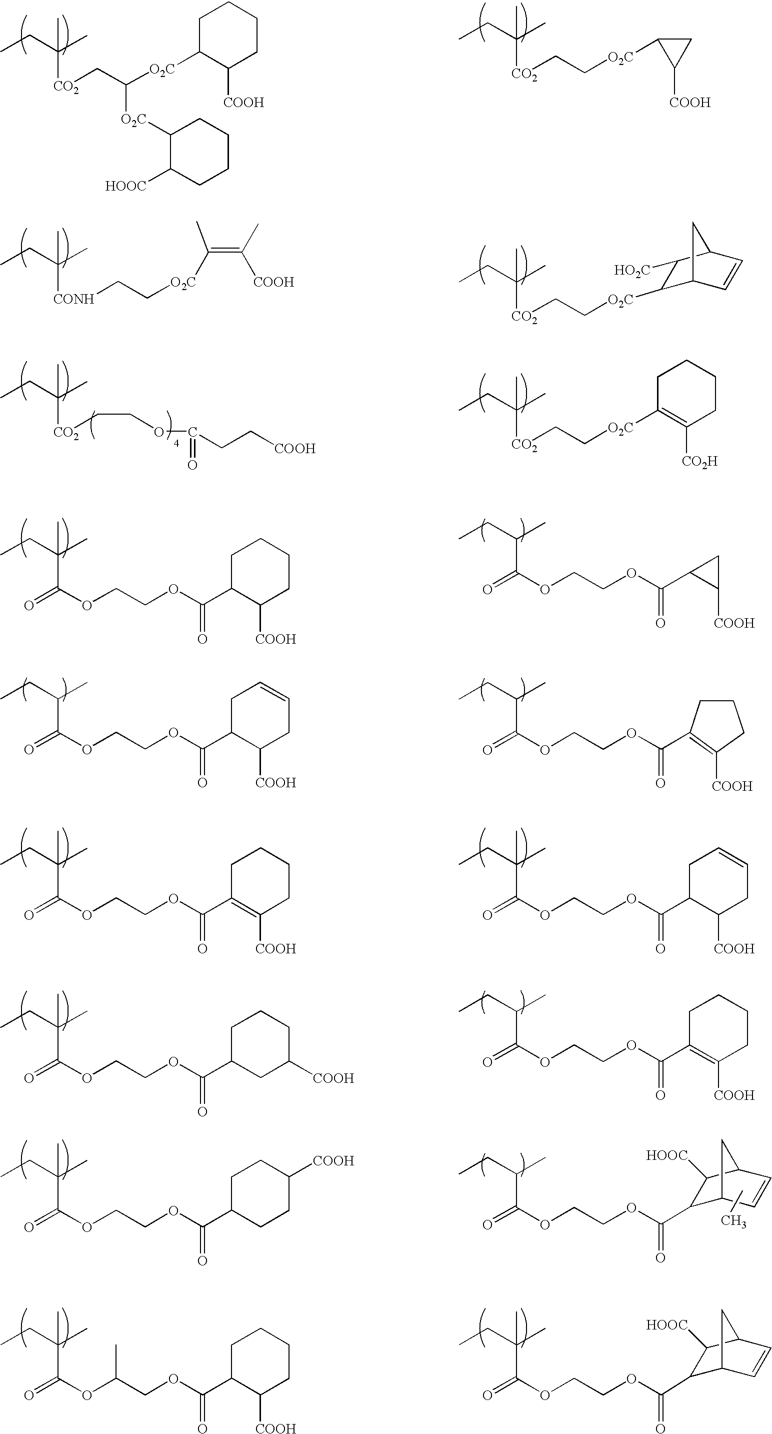

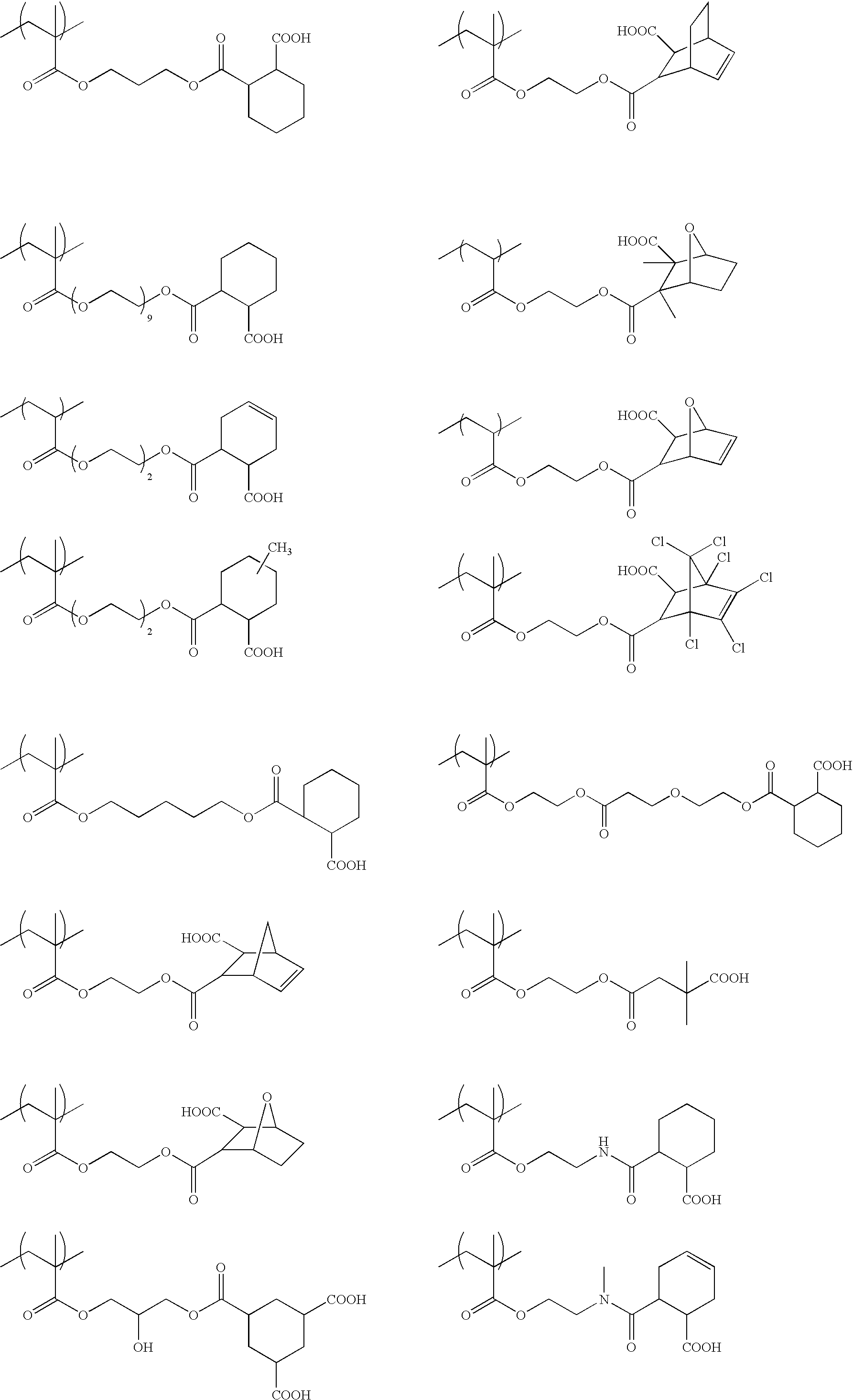

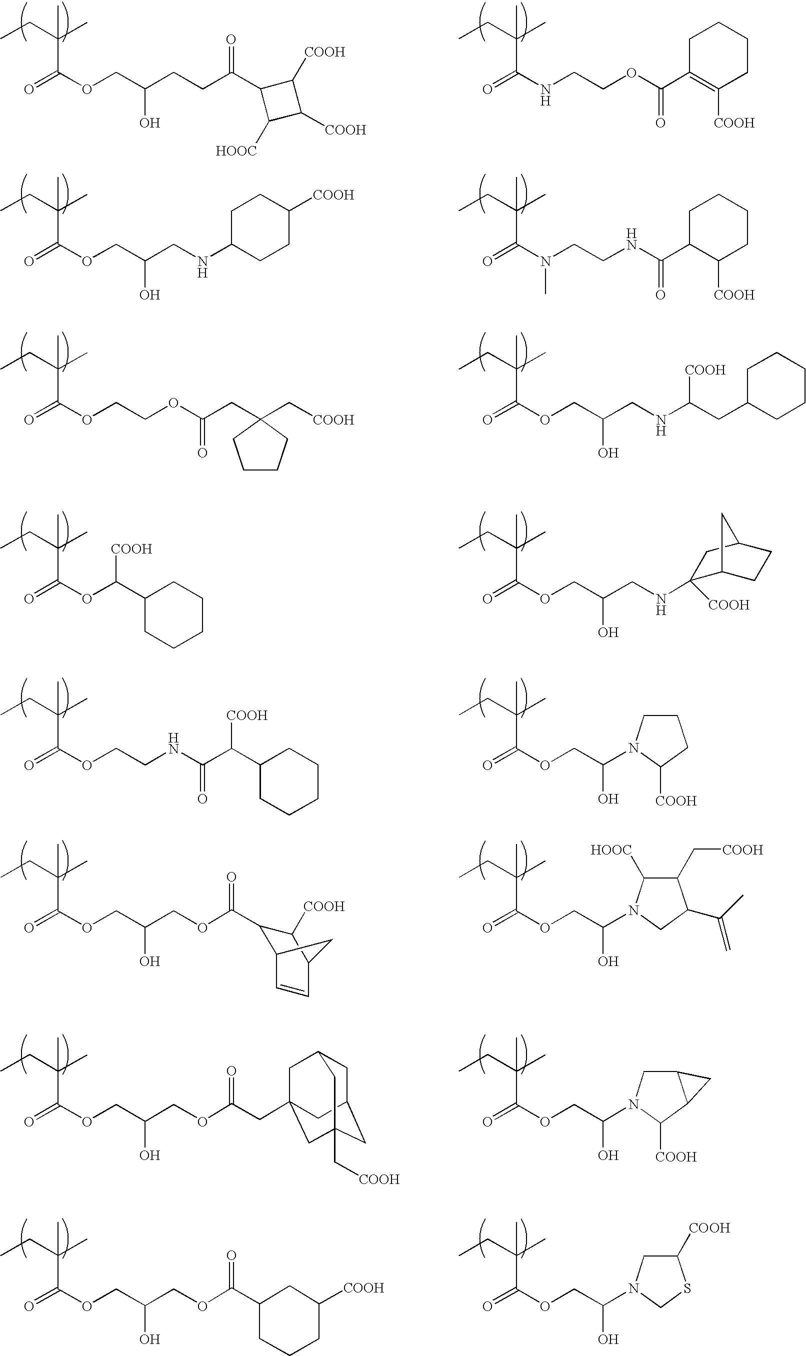

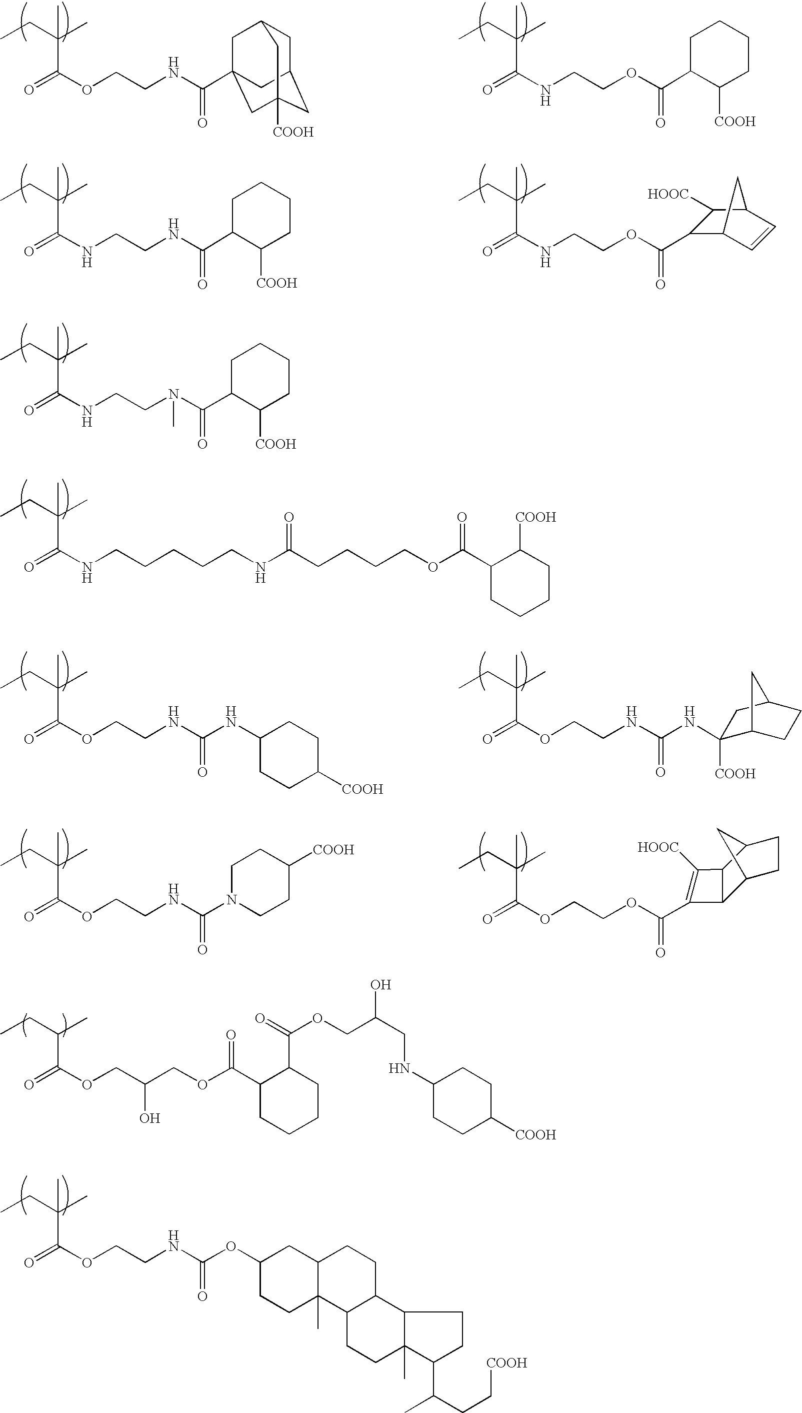

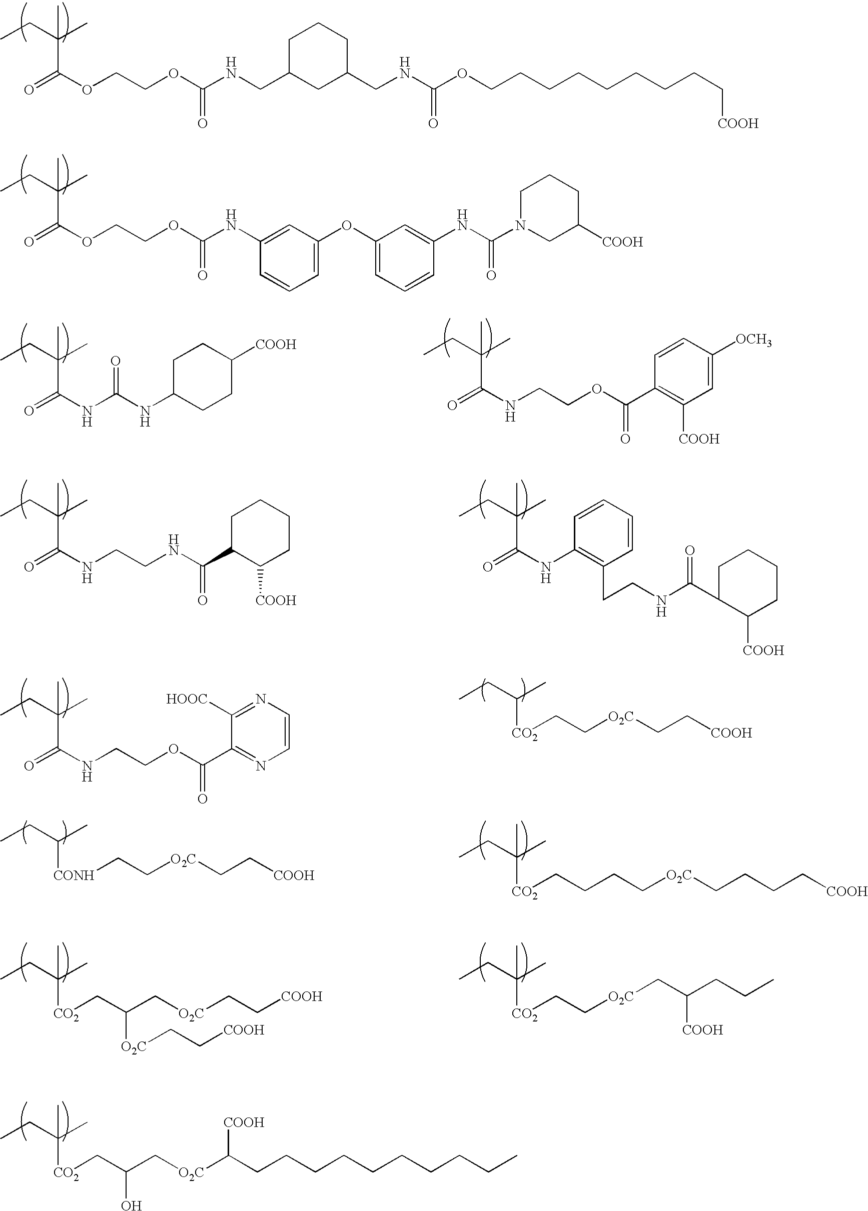

One or two or more kinds of repeating unit represented by formula (i) may be contained in the binder polymer. The specific binder polymer in the present invention may be a polymer composed exclusively of the repeating unit represented by formula (i), but is usually used as a copolymer containing other copolymerizable components. The total content of the repeating unit represented by formula (i) in the copolymer is suitably determined depending on the structure of the copolymer, design of the photosensitive layer, etc., but usually the repeating unit is contained in an amount of 1 to 99% by mole, more preferably 5 to 40% by mole, and still more preferably 5 to 20% by mole, based on the total molar amount of the polymer components.

When a copolymer is used as the binder polymer, copolymerizable components known in the art can be used without limitation insofar as they are radical-polymerizable monomers. Specifically, monomers described in the Polymer Data Handbook—Fundamental Version— compiled by the Society of Polymer Science, Japan and published by Baifukan, 1986 are exemplified. Such copolymerizable components can be used alone or in combination.

The molecular weight of the specific binder polymer in the present invention is suitably determined from the viewpoint of image-forming property and printing durability. Usually, when the molecular weight is increased, printing durability is improved but the image-forming property tends to be deteriorated. On the other hand, when the molecular weight is decreased, the image-forming property is improved, while printing durability is deteriorated. The molecular weight is preferably in the range of 2,000 to 1,000,000, more preferably 5,000 to 500,000, and still more preferably 10,000 to 200,000.

As the binder polymer used in the photosensitive layer in the planographic printing plate precursor of the present invention, the specific binder polymer may be used alone, or may be used in combination with one or more other binder polymers. When the specific binder is used, binder polymers used in combination therewith are used in the range of 1 to 60% by mass, preferably 1 to 40% by mass, and more preferably 1 to 20% by mass, based on the total weight of the binder polymer components. As the binder polymer, any known binder polymers can be used without limitation, and specifically an acrylic main-chain binder and a urethane binder used often in this field are preferably used.

The total amount of the specific binder polymer and binder polymers which can be used in combination therewith in the photosensitive layer can be suitably determined, and is usually 10 to 90% by mass, preferably 20 to 80% by mass, and more preferably 30 to 70% by mass, based on the total weight of nonvolatile components in the photosensitive layer.

The acid value (meg/g) of the binder polymer is preferably in the range of 2.00 to 3.60.

(Other Binder Polymers Usable in Combination)

The binder polymer which can be used in combination with the specific binder polymer is preferably a binder polymer having a radical-polymerizable group. The radical-polymerizable group is not particularly limited insofar as it can be polymerized with a radical, and examples thereof include α-substituted methyl acryl group [—OC(═O)—C(—CH₂Z)═CH₂ wherein Z is a hydrocarbon group starting from a heteroatom], acryl group, methacryl group, allyl group and styryl group, among which an acryl group and methacryl group are preferable.

The content of the radical-polymerizable group in the binder polymer (content of radical-polymerizable unsaturated double bonds determined by iodine titration) is preferably 0.1 to 10.0 mmol, more preferably 1.0 to 7.0 mmol, and most preferably 2.0 to 5.5 mmol, per g of the binder polymer. When this content is lower than 0.1 mmol, the curing properties may be deteriorated to be less sensitive. When the content is higher than 10.0 mmol, stability may be lost and storability may deteriorate.

Preferably, the binder polymer further has an alkali-soluble group. The content of the alkali-soluble group (acid value determined by neutralization titration) in the binder polymer is preferably 0.1 to 3.0 mmol, more preferably 0.2 to 2.0 mmol, and most preferably 0.45 to 1.0 mmol, per g of the binder polymer. When the content is lower than 0.1 mmol, the binder polymer may be precipitated during development to generate development scum. When the content is higher than 3.0 mmol, the hydrophilicity of the binder polymer may be too high, thus deteriorating printing durability.

The mass-average molecular weight of the binder polymer is in the range of preferably 2,000 to 1,000,000, more preferably 10,000 to 300,000, and most preferably 20,000 to 200,000. When the mass-average molecular weight is less than 2,000, the layer-forming property may be lowered to deteriorate printing durability. When the mass-average molecular weight is greater than 1,000,000, it may be difficult to dissolve the binder polymer in a coating solvent, thus resulting in deteriorating the coating property.

The glass transition point (Tg) of the binder polymer is in the range of preferably 70° to 300° C., more preferably 80° to 250° C., and most preferably 90° to 200° C. When the glass transition point is lower than 70° C., storability may become poor, thus deteriorating printing durability. When the glass transition point is higher than 300° C., the mobility of radicals in the photosensitive layer may be lowered, thus making sensitivity low.

As a means of increasing the glass transition point of the binder polymer, its molecule preferably contains an amide group or imide group, and particularly preferably contains methacrylamide derivatives.

In addition to the fundamental components described above, other components suitable for use, production process, etc., can be added to a heat-polymerizable negative type photosensitive layer preferable as the photosensitive layer in the planographic printing plate precursor of the present invention as necessary, such as various additives like coloring agents, plasticizers and polymerization inhibitors. Hereinafter, preferable examples of the additives are described.

(Polymerization Inhibitor)

A small amount of a heat-polymerization inhibitor is preferably added to the photosensitive layer in the planographic printing plate precursor of the present invention in order to inhibit undesired heat polymerization of the polymerizable compound having an ethylenically unsaturated double bond, either during the production or storage of the negative type photosensitive composition. Preferable examples of the heat-polymerization inhibitor include hydroquinone, p-methoxyphenol, di-t-butyl-p-cresol, pyrogallol, t-butyl catechol, benzoquinone, 4,4′-thiobis(3-methyl-6-t-butyl phenol), 2,2′-methylene bis(4-methyl-6-t-butyl phenol), N-nitrosophenyl hydroxylamine primary cerium salts, etc. The amount of the heat-polymerization inhibitor added is preferably about 0.01 to about 5% by mass relative to the weight of nonvolatile components in the entire composition. To prevent the inhibition of polymerization by oxygen, a higher fatty acid derivative such as behenic acid or behenic amide may be added as necessary so that it is allowed to be locally present on the surface of the photosensitive layer in the drying step after application. The amount of the higher fatty acid derivative added is preferably about 0.5 to about 10% by mass relative to nonvolatile components in the entire composition.

(Coloring Agent)

Dyes or pigments may be added to the photosensitive layer in the planographic printing plate precursor of the present invention for the purpose of coloring the photosensitive layer. The plate-checking property, that is, the visibility of the printing plate after plate-making and the applicability for image densitometer can thereby be improved. When dyes are used as the coloring agent, many of these can cause a reduction in the sensitivity of the photo-polymerizable photosensitive layer, and thus, it is particularly preferable to use pigments as the coloring agent. Examples of the coloring agent include pigments such as phthalocyanine type pigments, azo type pigments, carbon black and titanium oxide, and dyes such as ethyl violet, crystal violet, azo type dyes, anthraquinone type dyes and cyanine type dyes. The amount of the dyes and pigments added is preferably about 0.5 to about 5% by mass of nonvolatile components in the entire composition.

(Other Additives)

Known additives such as inorganic fillers for improving the physical properties of the cured layer, as well as other plasticizers and sensitizers for improving inking properties on the surface of the photosensitive layer may also be added. The plasticizers include dioctyl phthalate, didodecyl phthalate, triethylene glycol dicaprylate, dimethyl glycol phthalate, tricresyl phosphate, dioctyl adipate, dibutyl sebacate, triacetyl glycerin, etc., and these can be added in an amount of 10% by mass or less relative to the total weight of the binder polymer and the addition-polymerizable compound. UV initiators and heat-crosslinking agents for enhancing the effect of heating and irradiation after development can also be added for the purpose of improving the layer strength (printing durability) described later.

When the photosensitive layer is arranged by coating, the photopolymerizable composition of the photosensitive layer components is dissolved in various organic solvents and applied onto the above-described substrate or the intermediate layer. The solvent used includes acetone, methyl ethyl ketone, cyclohexane, ethyl acetate, ethylene dichloride, tetrahydrofuran, toluene, ethylene glycol monomethyl ether, ethylene glycol monoethyl ether, ethylene glycol dimethyl ether, propylene glycol monomethyl ether, propylene glycol monoethyl ether, acetyl acetone, cyclohexanone, diacetone alcohol, ethylene glycol monomethyl ether acetate, ethylene glycol ethyl ether acetate, ethylene glycol monoisopropyl ether, ethylene glycol monobutyl ether acetate, 3-methoxy propanol, methoxy methoxy ethanol, diethylene glycol monomethyl ether, diethylene glycol monoethyl ether, diethylene glycol dimethyl ether, diethylene glycol diethyl ether, propylene glycol monomethyl ether acetate, propylene glycol monoethyl ether acetate, 3-methoxy propyl acetate, N,N-dimethyl formamide, dimethyl sulfoxide, γ-butyrolactone, methyl lactate and ethyl lactate. These solvents can be used singly or in combination. The solid content of the coating solution is suitably 2 to 50% by mass.

The coating amount of the photosensitive layer mainly affects the sensitivity and developability of the photosensitive layer and the strength and printing durability of the layer exposed to light, and is desirably selected depending on the use. When the coating amount is too low, the printing durability is not sufficient. It is not preferable for the coating amount to be too high because sensitivity is reduced, light exposure requires longer time, and a longer time is necessary for development processing. The coating amount of the photosensitive layer on the planographic printing plate precursor for scanning light exposure as the major object of the present invention is preferably in the range of about 0.1 to 10 g/m², and more preferably 0.5 to 5 g/m², in terms of dried mass.

(Physical Properties of the Photosensitive Layer)

The physical properties of the photosensitive layer in the present invention are preferably that the development rate of light-unexposed areas with an alkali developing solution having a pH value of 10 to 13.5 is not less than 80 nm/sec., and the permeation rate of the alkali developing solution into light-exposed areas is not higher than 100 nF/sec.

The development rate with an alkali developing solution having a pH value of 10 to 13.5 is a value obtained by dividing the thickness (nm) of the photosensitive layer by time (sec) necessary for development, and the permeation rate of the alkali developing solution is a value indicative of a rate of change, upon dipping in a developing solution, in the electrostatic capacity (F) of the photosensitive layer formed on an electroconductive substrate.

Hereinafter, the methods of measuring “the development rate with an alkali developing solution” and “the permeation rate of an alkali developing solution” are described below.

<Measurement of the Development Rate With an Alkali Developing Solution>

The development rate of the photosensitive layer with the alkali developing solution is a value obtained by dividing the thickness (nm) of the photosensitive layer by time (sec) necessary for development.

The development rate in the present invention was measured by a DRM interferometer for measuring the dissolution behavior of a photosensitive layer by dipping an aluminum substrate provided with a light-unexposed photosensitive layer in a predetermined alkali developing solution (30° C.) at a predetermined pH value in the range of pH value of 10 to 13.5, as shown in FIG. 1. FIG. 1 is a schematic view of the DRM interferometer for measuring the dissolution behavior of a photosensitive layer. In the present invention, the change in the layer thickness was detected by interference with a light of 640 nm. When the development behavior is non-swelling development starting from the surface of the photosensitive layer, the layer thickness is gradually decreased in proportion to the development time to give interference waves depending on the thickness. In the case of swelling dissolution (dissolution to remove the layer), the layer thickness is changed depending on the permeation of the developing solution, thus failing to give regular interference waves.

The development time (sec) in which the photosensitive layer is completely removed (i.e., the thickness of the layer becomes 0) under these conditions is then determined, and from this development time (sec) and the thickness (nm) of the photosensitive layer, the development rate can be determined from the equation below. A higher development rate indicates easier removal of the layer with the developing solution, that is, good developability.

Development rate (of light-unexposed area)=[(thickness of photosensitive layer (nm)/development time (sec)]

<Measurement of the Permeation Rate of the Alkali Developing Solution>

The permeation rate of the alkali developing solution is a value indicative of a rate of change, upon dipping in a developing solution, in the electrostatic capacity (F) of the photosensitive layer formed on an electroconductive substrate.

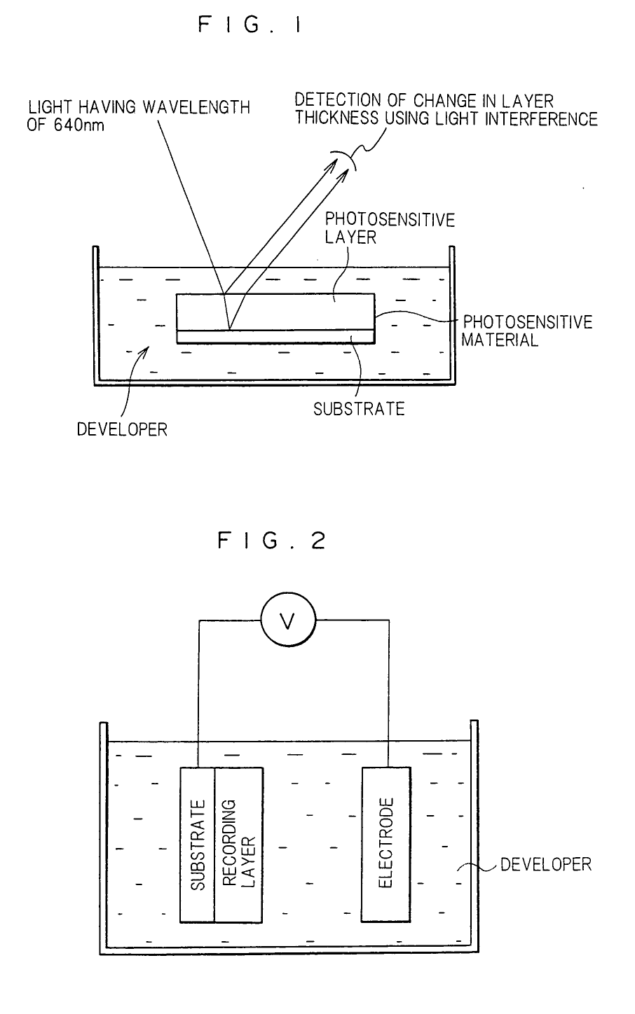

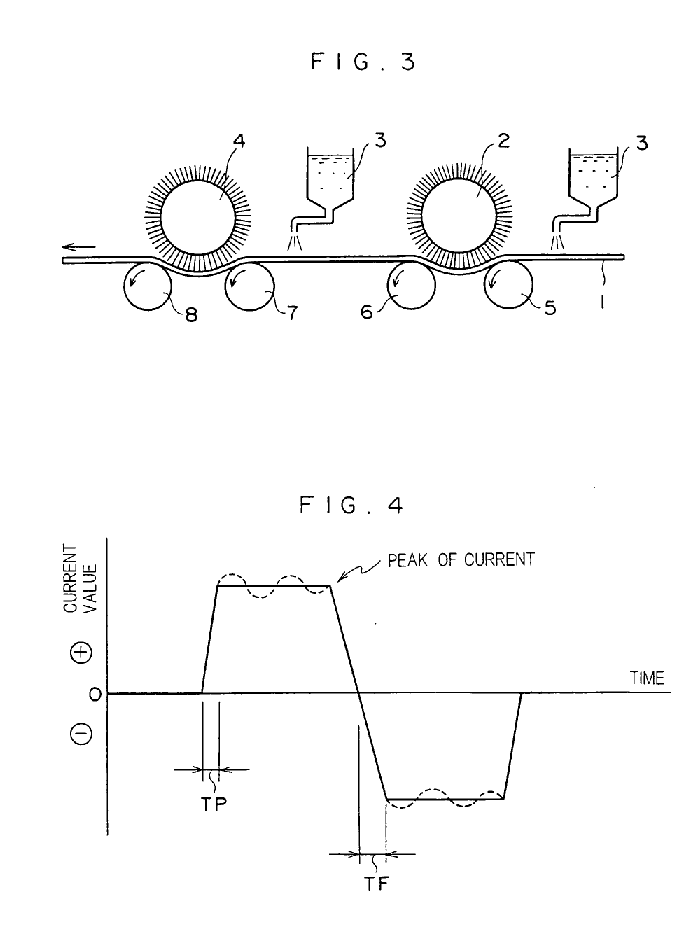

As shown in FIG. 2, the method of measuring electrostatic capacity as an indicator of permeability in the present invention includes a method wherein a voltage between an aluminum substrate having a cured photosensitive layer thereon used as one electrode and a usual electrode as the other electrode are applied via a conductor wire between the electrodes in a predetermined alkali developing solution (28° C.) in the range of pH value of 10 to 13.5. After applying the voltage, the developing solution is permeated into the interface between the substrate and the photosensitive layer, to change the electrostatic capacity in proportion to the dipping time.

From the time (sec) necessary for the change in the electrostatic capacity to become constant and the saturation value (nF) of the electrostatic capacity of the photosensitive layer, the permeation rate can be determined according to the following equation. A smaller permeation rate is indicative of lower permeability of the developing solution.

Rate of permeation of the developing solution (into light-exposed area) (nF/sec)=[saturation value of the electrostatic capacity of the photosensitive layer (nF)/time (sec) necessary for the change in electrostatic capacity to become constant]

The properties of the photosensitive layer in the planographic printing plate precursor of the present invention are preferably that the development rate of light-unexposed area with an alkali developing solution at a pH value of 10 to 13.5 is preferably 80 to 400 nm/sec., and the rate of permeation of the alkali developing solution into the photosensitive layer is preferably not higher than 90 nF/sec., as determined by the method described above. The development rate of light-unexposed areas with an alkali developing solution at a pH value of 10 to 13.5 is more preferably 90 to 200 nm/sec., and the rate of permeation of the alkali developing solution into the photosensitive layer is more preferably not higher than 80 nF/sec., as determined by the method described above. The upper limit of the development rate or the lower limit of the permeation rate is not particularly limited, but it is preferable in consideration of the balance between the two rates that the development rate of light-unexposed areas is in the range of 90 to 200 nm/sec., and the rate of permeation of the alkali developing solution into the photosensitive layer is preferably not higher than 80 nF/sec.

The rate of development of light-unexposed areas of the photosensitive layer and the rate of permeation of the alkali developing solution into the photosensitive layer after curing can be regulated in a usual manner, and typically, addition of a hydrophilic compound is useful for improvement of the rate of development of the light-unexposed areas, and addition of a hydrophobic compound is useful for inhibition of permeation of the developing solution into light-exposed areas. By using the specific binder polymer in the present invention, the development rate of the photosensitive layer and the permeation rate of the developing solution can be regulated in the preferable ranges described above.

[Intermediate Layer (Undercoat Layer)]

For the purpose of preventing tinting and improving adhesiveness between the photosensitive layer and the substrate, an intermediate layer (undercoat layer) may be arranged in the planographic printing plate precursor in the present invention. Examples of such intermediate layers include those described in JP-B No. 50-7481, Japanese Patent Application Laid-Open (JP-A) Nos. 54-72104, 59-101651, 60-149491, 60-232998, 3-56177, 4-282637, 5-16558, 5-246171, 7-159983, 7-314937, 8-202025, 8-320551, 9-34104, 9-236911, 9-269593, 10-69092, 10-115931, 10-161317, 10-260536, 10-282682, 11-84674, 10-069092, 10-115931, 11-038635, 11-034634, 10-282465, 10-301262, 11-024277, 11-109641, 10-319600, 11-084674, 11-327152, 2000-010292, 2000-235254, 2000-352824, and 2001-209170.

[Protective Layer]

Because the photosensitive layer of the planographic printing plate precursor of the present invention is a heat-polymerizable negative type photosensitive layer, a protective layer (also called an overcoat layer) is usually preferably arranged on the photosensitive layer in order to conduct light exposure in the atmosphere. The protective layer prevents the photosensitive layer from being contaminated with low-molecular compounds existing in the atmosphere, such as oxygen and basic substances which inhibit image-forming reaction occurring in the photosensitive layer upon exposure of the photosensitive layer to light, thus enabling light exposure in the atmosphere. Accordingly, desired characteristics of the protective layer are that the layer is hardly permeated with low-molecular compounds such as oxygen, does substantially not inhibit transmission of light used in light exposure, has excellent adhesiveness to the photosensitive layer and can be easily removed in a development step after light exposure. The protective layer has been devised and described in detail in U.S. Pat. No. 3,458,311 and JP-B No. 55-49729.

The materials usable in the protective layer are preferably water-soluble polymers having relatively good crystallinity, and examples thereof include water-soluble polymers such as polyvinyl alcohol, polyvinyl pyrrolidone, acidic celluloses, gelatin, gum arabic and polyacrylic acid. Among these compounds, polyvinyl alcohol can be used as a major component to give the best result to basic characteristics such as oxygen impermeability and removability by development.

The polyvinyl alcohol (PVA) used in the protective layer may be partially replaced by ester, ether and acetal insofar as it has unsubstituted vinyl alcohol units for giving necessary oxygen impermeability and water solubility. Similarly, it may partially have other copolymerizable components.

Examples of the polyvinyl alcohol include those hydrolyzedatadegree of 71 to 100%, having 300 to 2400 repeating units. Specific examples include PVA-105, PVA-110, PVA-117, PVA-117H, PVA-120, PVA-124, PVA-124H, PVA-CS, PVA-CST, PVA-HC, PVA-203, PVA-204, PVA-205, PVA-210, PVA-217, PVA-220, PVA-224, PVA-217EE, PVA-217E, PVA-220E, PVA-224E, PVA-405, PVA-420, PVA-613, L-8, etc. which are available from Kuraray Co., Ltd.

The components (PVA selected and additives used) in the protective layer, the coating amount, etc. are selected in consideration of properties such as fogging, adhesiveness and scratch resistance, in addition to oxygen impermeability and removability by development. In general, as the degree of hydrolysis of PVA used becomes higher (or the content of unsubstituted vinyl alcohol units in the protective layer becomes higher) or as the thickness of the layer is increased, higher oxygen impermeability occurs, which is advantageous in terms of sensitivity. However, if the oxygen impermeability becomes extremely high, an undesired polymerization reaction may occur during production or storage, or unnecessary fogging and dot gain may be generated upon exposure of the photosensitive layer to light. In addition, the adhesiveness of the protective layer to an image area in the photosensitive layer and the anti-scratch property thereof are very important for handling of the plate. Namely, when a hydrophilic layer containing a water-soluble polymer is laminated on a hydrophobic layer, layer separation occurs easily due to insufficient adhesiveness between the two layers, and the separated portion causes deficiency such as insufficient layer curing attributable to polymerization inhibition with oxygen. In order to solve this problem, various proposals for improving the adhesiveness between the two layers have been made. For example, U.S. patent application Ser. Nos. 292,501 and 44,563 describe that an acrylic emulsion, a water-insoluble vinyl pyrrolidone-vinyl acetate copolymer, etc. are mixed in an amount of 20 to 60% by mass in a hydrophilic polymer containing mainly polyvinyl alcohol and then laminated on a photosensitive layer thereby achieving satisfactory adhesiveness.

Any of these known techniques can be applied to the protective layer in the present invention. The method of applying the protective layer is described in detail, for example, in U.S. Pat. No. 3,458,311 and JP-B No. 55-49729.

The process of at least light exposure and development is carried out for making a planographic printing plate from the planographic printing plate precursor of the present invention.

The light source used in the step of light exposure is preferably an IR laser, and thermal recording with a UV lamp or a thermal head is also feasible.

In, The planographic printing plate precursor of the present invention is preferably image wisely expososed with infrared rays of wavelengths of 750 nm to 1400 nm emitted from a solid laser or a semiconductor laser. The output power of the laser is preferably 100 mW or more, and a multi-beam laser device is preferably used to reduce the light exposure time. The light exposure time per pixel is preferably within 20 μsec. The energy irradiated on the planographic printing plate precursor is preferably 10 to 300 mJ/cm². When the energy for light exposure is too low, the curing of the photosensitive layer does not sufficiently proceed. When the energy for light exposure is too high, the image-recording layer may be ablated with the laser to damage the image.

The light exposure in the present invention can be carried out by overlapping beams from light sources. The term “overlapping” means that the sub-scanning pitch width (the distance between beam centers in the sub-scanning direction) is smaller than the beam diameter. For example, when the beam diameter is expressed in terms of FWHM, the overlapping can be quantitatively expressed as FWHM/sub-scanning pitch width (overlapping coefficient). In the present invention, the overlapping coefficient is preferably 0.1 or higher.

The scanning system using a light source in the light exposure device of the present invention is not particularly limited, and known scanning methods such as a drum outer surface scanning method, a drum inner surface scanning method or a flatbed scanning method can be used. The channel of the light source may be a single or multi-channel, but in the case of the drum outer surface scanning method, a multi-channel is preferably used.

In the present invention, development process may be carried out immediately after light-exposure, however, it is preferable that the development process is carried out after heat treatment, that is, that heat treatment is carried out between the light exposure step and the development step. This heat treatment is carried out preferably for a time between 5 seconds to 5 minutes at a temperature in the range of 60° to 150° C.

The heat treatment can be carried out by a method selected from various known methods in the art. Examples of such methods include a heating a planographic printing plate precursor functioning as the image forming material by bringing the printing plate precursor into contact with a panel heater or a ceramic heater, and, in a non-contact system, heating the printing plate precursor with a lamp or hot air. By subjecting the printing plate precursor to such heat treatment, the amount of laser energy necessary for recording an image can be reduced.

In the embodiment wherein the planographic printing plate precursor of the present invention has a protective layer, pre-washing with water to remove the protective layer may be carried out before the development step. Pre-washing with water is carried out, for example, by discharging water from a spray pipe to the surface of the protective layer of the planographic printing plate precursor, to moisten the protective layer, and then removing the protective layer with a brush roller. In pre-washing, tap water for example is used. When the development step is carried out in an automatic developing machine, the pre-washing step may be carried out in the automatic developing machine.

The planographic printing plate precursor of the present invention is subjected to developing process after light exposure, or after a heating step or a pre-washing step. The developing solution used in the developing process is particularly preferably an aqueous alkali solution at a pH value of 14 or less, more preferably an aqueous alkali solution at a pH value of 8 to 12 containing an anionic surfactant. For example, Inorganic alkalis such as trisodium phosphate, tripotassium phosphate, triammonium phosphate, disodium hydrogen phosphate, dipotassium hydrogen phosphate, diammonium hydrogen phosphate, sodium carbonate, potassium carbonate, ammonium carbonate, sodium bicarbonate, potassium bicarbonate, ammonium bicarbonate, sodium borate, potassium borate, ammonium borate, sodium hydroxide, ammonium hydroxide, potassium hydroxide and lithium hydroxide are exemplified. Organic alkalis such as monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethylene imine, ethylene diamine, and pyridine can be used. These alkalis are used singly or in combination thereof.

In the developing process of the planographic printing plate precursor of the present invention, an anionic surfactant is added in an amount of 1 to 20% by mass, preferably 3 to 10% by mass, to the developing solution. When the amount thereof is too low, the developability is deteriorated, while when the amount is too high, the strength of image areas, such as abrasion resistance, may be deteriorated. The anionic surfactant includes, for example, sodium salt of lauryl alcohol sulfate, ammonium salt of lauryl alcohol sulfate, sodium salt of octyl alcohol sulfate, alkyl aryl sulfonates such as sodium isopropyl naphthalene sulfonate, sodium isobutyl naphthalene sulfonate, sodium polyoxyethylene glycol mononaphthyl ether sulfate, sodium dodecyl benzene sulfonate and sodium m-nitrobenzene sulfonate, higher alcohol sulfates having 8 to 22 carbon atoms such as sodium secondary alkyl sulfate, fatty alcohol phosphates such as sodium cetyl alcohol phosphate, alkylamide sulfonates such as C₁₇H₃₃CON(CH₃)CH₂CH₂SO₃Na, and dibasic aliphatic sulfonates such as sodium dioctyl sulfosuccinate and sodium dihexyl sulfosuccinate.

If necessary, an organic solvent such as benzyl alcohol miscible with water may be added to the developing solution. The organic solvent is preferably the one having a water solubility of about 10% by mass or less, more preferably 5% by mass or less. Examples of such organic solvents include 1-phenyl ethanol, 2-phenyl ethanol, 3-phenyl propanol, 1,4-phenyl butanol, 2,2-phenyl butanol, 1,2-phenoxy ethanol, 2-benzyloxy ethanol, o-methoxy benzyl alcohol, m-methoxy benzyl alcohol, p-methoxy benzyl alcohol, benzyl alcohol, cyclohexanol, 2-methyl cyclohexanol, 4-methyl cyclohexanol and 3-methyl cyclohexanol. The content of the organic solvent is preferably 1 to 5% by mass relative to the total mass of the developing solution used. The amount of the organic solvent used is related closely to the amount of the surfactant used, and as the amount of the organic solvent is increased, the amount of the anionic surfactant is preferably increased. This is because if the organic solvent is used in a higher amount in the presence of a smaller amount of an anionic surfactant, the organic solvent is not dissolved, thus failing to secure good developability.

If necessary, additives such as a deforming agent and hard water-softening agent can be contained in the developing solution. The hard water-softening agent includes, for example, polyphosphates such as Na₂P₂O₇, Na₅P₃O₃, Na₃P₃O₉, Na₂O₄P(NaO₃P)PO₃Na₂, and Calgon (sodium polymetaphosphate), aminopolycarboxylic acids (for example, ethylenediaminetetraacetic acid, potassium salt thereof, sodium salt thereof; diethylenetriaminepentaacetic acid, potassium salt thereof, sodium salt thereof; triethylenetetraminehexaacetic acid, potassium salt thereof, sodium salt thereof; hydroxyethylenediaminetriacetic acid, potassium salt thereof, sodium salt thereof; nitrilotriacetic acid, potassium salt thereof, sodium salt thereof; 1,2-diaminocyclohexanetetraacetic acid, potassium salt thereof, sodium salt thereof; 1,3-diamino-2-propanol tetraacetic acid, potassium salt thereof, sodium salt thereof); other polycarboxylic acids (for example, 2-phosphonobutanetricarboxylic acid-1,2,4, potassium salt thereof, sodium salt thereof; 2-phosphonobutanonetricarboxylic acid-2,3,4, potassium salt thereof, sodium salt thereof), organic phosphonic acids (for example, 1-phosphonoethanetricarboxylic acid-1,2,2, potassium salt thereof, sodium salt thereof; 1-hydroxyethane-1,1-diphosphonic acid, potassium salt thereof, sodium salt thereof; and aminotri (methylene phosphonic acid), potassium salt thereof, and sodium salt thereof. The optimum amount of the hard water-softening agent is varied depending on the hardness and amount of hard water used, but generally the hard water-softening agent is contained in the range of 0.01 to 5% by mass, more preferably 0.01 to 0.5% by mass, in the developing solution used.

When the planographic printing plate precursor is developed by an automatic developing machine, the developing solution is exhausted depending on throughput, and thus throughput capacity may be recovered using a replenishing solution or a fresh developing solution. In this case, the solution is replenished by a method described in U.S. Pat. No. 4,882,246. Developing solutions described in JP-A Nos. 50-26601, 58-54341, JP-B Nos. 56-39464, 56-42860 and 57-7427 are also preferable.

The planographic printing plate precursor which was subjected in this manner to development process is post-processed with washing water, a surfactant-containing rinse, and a desensitizing solution containing gum arabic and starch derivatives, as described in JP-A Nos. 54-8002, 55-115045 and 59-58431. These processes can be used in combination as post-processing of the planographic printing plate precursor of the present invention.

In the method of producing the planographic printing plate precursor of the present invention, the whole surface of the images after development is subjected to heating or light exposure for the purpose of improving strength of the image areas and printing durability.

Very severe conditions can be utilized in heating after development. Usually, heating is carried out in the range of 200 to 500° C. When the heating temperature after development is low, a sufficient image area strengthening effect cannot be achieved, while when the temperature is too high, there may arise problems such as deterioration of the substrate and thermal degradation of the image areas.

The planographic printing plate obtained by these treatments is loaded onto an offset printing machine, etc. and used for printing on a large number of papers.

At the time of printing, a plate cleaner used for dirt removal from the plate includes PS plate cleaners known in the art, such as CL-1, CL-2, CP, CN-4, CN, CG-1, PC-1, SR and IC (Fuji Photo Film Co., Ltd.).

### EXAMPLES

Hereinafter, the present invention will be described with reference to the following examples, but the present invention is not limited thereto.

### Examples 1 to 3, Comparative Examples 1 and 2

[Preparation of a Substrate]

<Aluminum Plate>

An aluminum alloy containing 0.06% by mass Si, 0.30% by mass Fe, 0.001% by mass Cu, 0.001% by mass Mn, 0.001% by mass Mg, 0.001% by mass Zn and 0.03% by mass Ti, the balance being Al and inevitable impurities, was used to prepare a melt, then subjected to a molten metal treatment, filtered and formed into an ingot of 500 mm in thickness and 1200 mm in width with a DC casting method. After its surface layer of 10 mm in average thickness was shaved with a surface shaving machine, the ingot was kept at 550° C. for about 5 hours, and when the temperature was reduced to 400° C., the ingot was formed into a rolled plate of 2.7 mm in thickness with a hot rolling mill. Then, the plate was subjected to heat treatment at 500° C. with a continuous annealing device and finished in cold rolling to give the plate a thickness of 0.24 mm as an aluminum plate of JIS 1050 material. This aluminum plate was formed into a plate of 1030 mm in width and then subjected to the following surface treatment.

<Surface Treatment>

In the surface treatment, the following treatments (a) to (j) were successively conducted. After each treatment and water washing, all remaining liquid was removed with nip rollers.

(a) Mechanical Surface Roughening Treatment

Using the device shown in FIG. 1, the surface of the aluminum plate was subjected to mechanical surface roughening treatment with a rotating roller-shaped nylon brush while being supplied with an aqueous suspension of an abrasive having a specific gravity of 1.12 (Pamis) as an abrasive slurry. In FIG. 1, 1 is the aluminum plate, 2 and 4 are roller-shaped brushes, 3 is the abrasive slurry, and 5, 6, 7 and 8 are supporting rollers. The average particle diameter of the abrasive was 30 μm, and the maximum particle diameter was 100 μm. The nylon brush was made of 6-10 nylon, the length of the brush bristle was 45 mm, and the diameter of the brush bristle was 0.3 mm. The nylon brush had bristles arranged densely in holes in a stainless steel cylinder of φ300 mm. Three rotating brushes were used. The distance between the two supporting rollers (φ200 nm) under the brushes was 300 mm. The brush roller was pressed against the aluminum plate until the loading of a driving motor for rotating the brush was increased to 7 kW plus relative to the loading before the brush roller was pressed against the aluminum plate. The direction of rotation of the brush was the same as the transporting direction of the aluminum plate. The number of revolutions of the brush was 200 rpm.

(b) Alkali Etching Treatment

The aluminum plate obtained above was subjected to etching treatment by spraying with an aqueous solution of sodium hydroxide at a concentration of 2.6% by mass and aluminum ion at a concentration of 6.5% by mass at a temperature of 70° C., whereby the aluminum plate was dissolved in an amount of 10 g/m². Thereafter, the aluminum plate was washed by spraying with water.

(c) Desmut Treatment

The aluminum plate was subjected to desmut treatment with an aqueous solution (containing 0.5% by mass aluminum ion) of 1% by mass nitric acid at a temperature of 30° C. and then washed by spraying with water. The aqueous solution of nitric acid used in desmut treatment was a waste liquid in the step of electrochemical surface roughening treatment with an alternating current in an aqueous solution of nitric acid.

(d) Electrochemical Surface Roughening Treatment

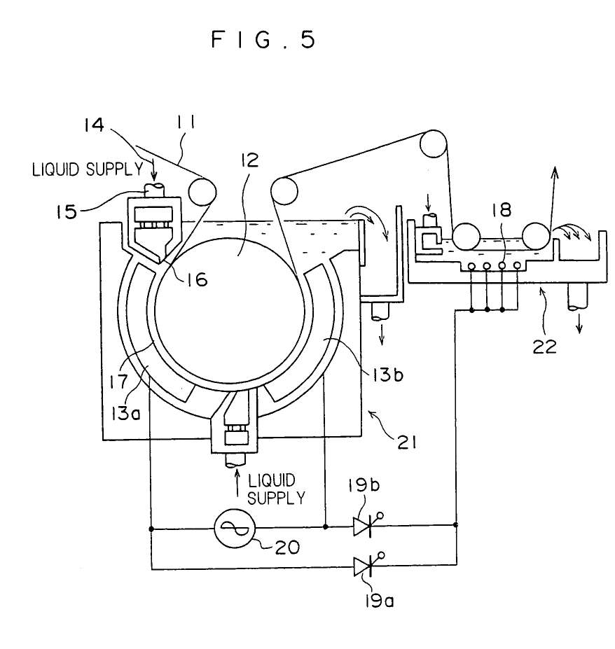

The plate was continuously subjected to electrochemical surface roughening treatment with an alternating voltage of 60 Hz. The electrolytic solution used was 10.5 g/L aqueous nitric acid solution (containing 5 g/L aluminum ion and 0.007% by mass ammonium ion) at a temperature of 50° C. The alternating current power source waveform is shown in FIG. 4, and the electrochemical surface roughening treatment was carried out with a carbon electrode as a counter electrode, wherein the time TP required for the electric current to reach from 0 to the peak was 0.8 msec., the duty ratio was 1:1 and a trapezoid rectangular wave alternating current was used. Ferrite was used as an auxiliary anode. The electrolytic bath used is shown in FIG. 5. In FIG. 5, Numeral 11 denotes an aluminum plate, 12 denotes a radial drum roller, 13a and 13b denote main electrodes, 14 denotes an electrolytic solution, 15 denotes an electrolytic solution supplying inlet, 16 denotes a slit, 17 denotes an electrolytic solution passage, 18 denotes an auxiliary anode, 19a and 19b denote thyristors, 20 denotes an alternate power source, 20 denotes an alternate current power source, and 21 denotes a main electrolytic bath.

The current density was 30 A/dm² in terms of the electric current peak, and the electrical quantity was 220 C/dm² in terms of the total electrical quantity upon anodizing of the aluminum plate. An effective shunt current of 5% of the electric current from the power source was fed to the auxiliary anode. Thereafter, the plate was washed by spraying with water.

(e) Alkali Etching Treatment

The aluminum plate was subjected to etching treatment by spraying with an aqueous solution of sodium hydroxide at a concentration of 26% by mass and aluminum ion at a concentration of 6.5% by mass at a temperature of 32° C., whereby the aluminum plate was dissolved in an amount of 0.50 g/m², and smut components based on aluminum hydroxide formed by the electrochemical surface roughening treatment using the alternating current in the previous stage were removed, and the edge of the formed pit was dissolved to smooth the edge. Thereafter, washing by spraying with water was carried out.

(f) Desmut Treatment

The aluminum plate was subjected to desmut treatment with an aqueous solution (containing 4.5% by mass aluminum ion) of 15% by mass nitric acid at a temperature of 30° C. and then washed by spraying with water. The aqueous solution of nitric acid used in desmut treatment was waste liquid in the step of electrochemical surface roughening treatment with an alternating current in an aqueous solution of nitric acid.

(g) Electrochemical Surface Roughening Treatment

The plate was subjected continuously to electrochemical surface roughening treatment with an alternating voltage of 60 Hz. The electrolyte used was 5.0 g/L aqueous hydrochloric acid solution (containing 5 g/L aluminum ion) at a temperature of 35° C. The alternating current power source waveform is shown in FIG. 4, and the electrochemical surface roughening treatment was carried out with a carbon electrode as a counter electrode, wherein the time TP required for the electric current to reach from 0 to the peak was 0.8 msec., the duty ratio was 1:1 and a trapezoid rectangular wave alternating current was used. Ferrite was used as an auxiliary anode. The electrolytic bath used is shown in FIG. 5.

The current density was 25 A/dm² in terms of the electric current peak, and the electrical quantity was 50 C/dm² in terms of the total electrical quantity upon anodizing of the aluminum plate. Thereafter, the plate was washed by spraying with water.

(h) Alkali Etching Treatment

The aluminum plate was subjected to etching treatment by spraying with an aqueous solution of sodium hydroxide at a concentration of 26% by mass and aluminum ion at a concentration of 6.5% by mass at a temperature of 32° C., whereby the aluminum plate was dissolved in an amount of 0.10 g/m², and smut components based on aluminum hydroxide formed by the electrochemical surface roughening treatment using the alternating current in the previous stage were removed, and the edge of the formed pit was dissolved to smooth the edge. Thereafter, washing by spraying with water was carried out.

(i) Desmut Treatment

The aluminum plate was subjected to desmut treatment with an aqueous solution (containing 0.5% by mass aluminum ion) of 25% by mass sulfuric acid at a temperature of 60° C. and then washed by spraying with water.

(j) Anodizing Treatment

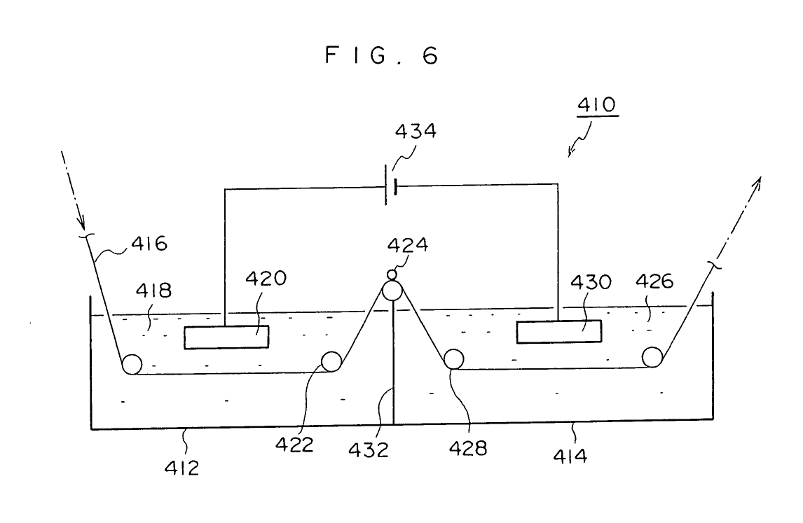

Anodizing treatment was carried out with an anodizing device having the structure shown in FIG. 6 to provide a substrate for planographic printing. In FIG. 6, Numeral 410 denotes an anodizing treatment device, 412 denotes a first electrolytic, 414 denotes a second electrolytic bath, 416 denotes an aluminum plate, 418 and 426 denotes electrolytic solutions, 420 denotes a power supplying electrode, 422 and 428 denote rollers, 424 denotes nip rollers, 430 denotes an electrolytic electrode, 432 denotes a bath wall, and 434 denotes a direct current power source.

The electrolytic solution supplied to the first and second electrolytic zones were sulfuric acid solution. Both the electrolytes were 170 g/L sulfuric acid (containing 0.5% by mass aluminum ion) at a temperature of 38° C. Thereafter, washing by spraying with water was carried out. The final anodized coating was 2.7 g/m². The central line average surface roughness Ra of the resultant aluminum substrate obtained by the above-described treatments is shown in Table 1.

[Undercoat]

Next, an undercoat solution shown below was applied by use of a wire bar onto the aluminum substrate and dried at 90° C. for 30 seconds in a hot-air drying oven. The amount of the coating after drying was 10 mg/m².

<Undercoat Solution>

| | |
|---|---|
| Ethyl acrylate/sodium 2-acrylamide-2-methyl-1- | 0.1 g |
| propanesulfonate copolymer (molar ratio 75:15) | |
| 2-Aminoethylphosphonic acid | 0.1 g |
| Methanol | 50 g |
| Deionized water | 50 g |

[Photosensitive Layer]

Next, the photosensitive layer coating solution [P-1] below was prepared and applied by the use of a wire bar onto the aluminum substrate which had been coated with the undercoat described above. The solution was dried at 125° C. for 27 seconds in a hot-air drying oven, to give a planographic printing plate precursor. The coating amount after drying was in the range of 1.2 to 1.3 g/m².

<Photosensitive layer coating solution [P-1]>

| | |
|---|---|
| Infrared absorbing agent (IR-1) | 0.08 g |
| Polymerization initiator (OS-1) | 0.2 g |
| Polymerization initiator (OS-2) | 0.05 g |
| Ethylenically unsaturated bond-containing compound (M-1) | 1.00 g |
| Binder polymer (BT-1) | 1.00 g |
| Ethyl violet chloride | 0.04 g |
| Fluorine-type surfactant (W-1) | 0.03 g |
| Stearoyl methyl amide | 0.06 g |
| Methyl ethyl ketone | 10.4 g |
| Methanol | 4.83 g |
| 1-Methoxy-2-propanol | 10.4 g |

The structures of the infrared absorbing agent (IR-1), the polymerization initiators (OS-1) and (OS-2), the ethylenically unsaturated bond-containing compound (M-1), the binder polymer (BT-1) and the fluorine-type surfactant (W-1) used in the photosensitive layer coating solution are shown below:

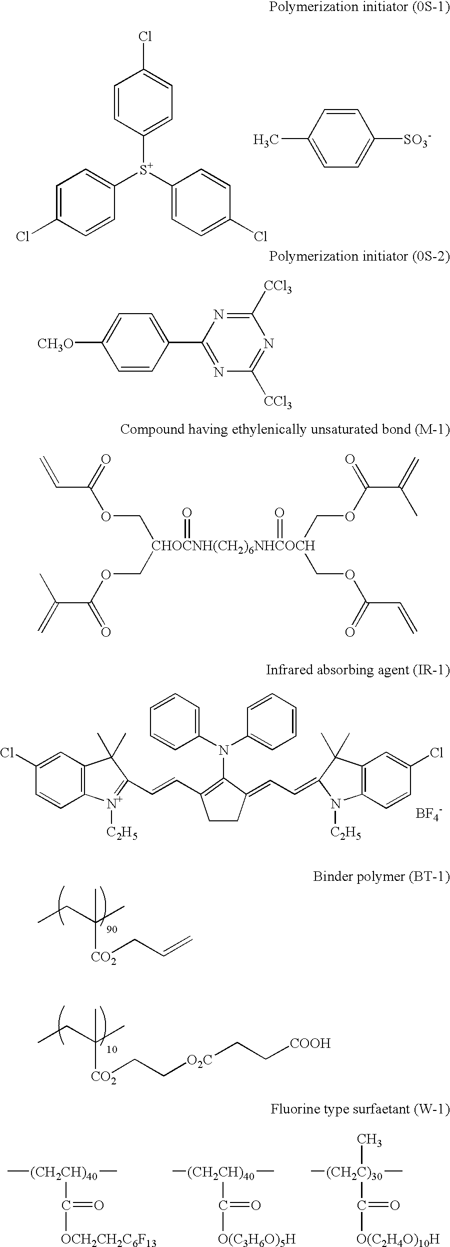

[Protective Layer (Overcoat Layer)]

An aqueous mixed solution of polyvinyl alcohol (degree of saponification, 98% by mole; degree of polymerization, 500) and polyvinyl pyrrolidone (Rubiscol K-30 manufactured by BASF) was applied onto the surface of the photosensitive layer by the use of a wire bar and dried at 100° C. for 90 seconds in a hot-air drying oven. The content of polyvinyl alcohol was 85% by mass, and the coating amount (coating amount after drying) was 2 g/m².

[Evaluation]

(1) Evaluation of Sensitivity

The resultant planographic printing plate precursor was exposed to light with output power in the range of 0 to 8 W changed by 0.15 in log E with a resolution of 175 lpi at an outer drum revolution number of 150 rpm by Trendsetter-3244VX (manufactured by CREO Co., Ltd.) equipped with a water-cooling 40-W infrared semiconductor laser. Light exposure was carried out under the condition of 50% RH at 25° C. After the light exposure, the protective layer was removed by washing with tap water, and development was carried out at 30° C. for 12 seconds in an automatic developing machine LP-1310HII manufactured by Fuji Photo Film Co., Ltd. A diluted solution of DV-2 (manufactured by Fuji Photo Film Co., Ltd.) with water in a ratio of 1:4 was used as the developing solution, and a diluted solution of FP-2W (manufactured by Fuji Photo Film Co., Ltd.) with water in a ratio of 1:1 was used as the finisher.

The density of the developed image area of the planographic printing plate was measured with a Macbeth reflection densitomer RD-918, and a red filter attached to the densitomer was used to measure the cyan density. A reciprocal number of the amount of exposure light necessary for attaining a density of 0.8 was used as an indicator of sensitivity. Assuming that the sensitivity of the planographic printing plate obtained in Example 1 was regarded as 100, the sensitivity of the other planographic printing plates is shown as relative sensitivity. A higher value is indicative of higher sensitivity.

(2) Evaluation of Raw Stock Storability

The unexposed planographic printing plate precursor was stored at 60° C. under 30% RH for 3 days and subjected to light exposure and development in the following method, and the density of the non-image area was measured by Macbeth reflection densitomer RD-918. The planographic printing plate precursor just after preparation was also subjected to light exposure and development in the same manner, and the density of the non-image area was measured. In this example, the difference Δfog between the fog densities in the non-image areas in these samples was determined and used as an indicator of raw stock storability. A smaller Δfog value indicates higher raw stock storability, and 0.02 or less is a practically usable level. The results are shown in Table 1.

(Light Exposure/development)

A solid image with a resolution of 1751 pi was printed on the planographic printing plate precursor with an output power of 8 W at an outer drum revolution number of 206 rpm with an energy of 100 mJ/cm² on the printing matrix by Trendsetter-3244VX (from CREO Co., Ltd.) equipped with a water-cooling 40-W infrared semiconductor laser. After the light exposure, the protective layer was removed by washing with tap water, and the image was developed in the same method as in (1) Evaluation of sensitivity above.

(3) Evaluation of Printing Durability

80% screen tint image with a resolution of 1751 pi was printed on the prepared planographic printing plate precursor with an output power of 8 W at an outer drum revolution number of 206 rpm with an energy of 100 mJ/cm² on the printing matrix by Trendsetter-3244VX (from CREO Co., Ltd.) equipped with a water-cooling 40-W infrared semiconductor laser. After the light exposure, the protective layer was removed by washing with tap water, and the image was developed in the same method as in (1) Evaluation of sensitivity above. The resulting planographic printing plate was used in printing with a printing machine Lithron manufactured by Komori Corporation. The number of complete prints was regarded as an indicator of printing durability. The results are shown in Table 1.

TABLE 1

| | Particle | | | | | |
|---|---|---|---|---|---|---|
| | Diameter of | Diameter of | Substrate | | Storability | Printing |
| | abrasive | Bristle | Ra | Sensitivity | of Raw Stack | Durability |
| | (μm) | (mm) | (μm) | 25° C. 50% RH | Δfog | (sheets) |
| Example 1 | 30 | 0.3 | 0.45 | 100 | 0.01 | 100000 |
| Example 2 | 20 | 0.3 | 0.35 | 105 | 0.02 | 100000 |
| Example 3 | 45 | 0.3 | 0.55 | 90 | 0.01 | 90000 |
| Comparative | 15 | 0.2 | 0.25 | 110 | 0.08 | 100000 |
| Example 1 | | | | | | |
| Comparative | 50 | 0.4 | 0.65 | 75 | ±0 | 30000 |
| Example 2 | | | | | | |

As is evident from Table 1, it was found that the planographic printing plate precursors in Examples 1 to 3 were superior to the planographic printing plate precursors in Comparative Examples 1 to 2 in terms of sensitivity, raw stock storability (stability with the lapse of time) and printing durability. On the other hand, it was found that the planographic printing plate precursor in Comparative Example 1 had excellent sensitivity and printing durability, but possessed very low raw stock storability because of the central line average surface roughness (Ra) of the substrate being too small, and was thus problematic in terms of actual use. It was also revealed that the planographic printing plate precursor in Comparative Example 2 had excellent raw stock storability, but had very low sensitivity and printing durability because the central line average surface roughness (Ra) of the substrate was too high.

According to the present invention, a negative type planographic printing plate precursor suitable for direct printing with an infrared laser is provided, having high sensitivity and printing durability and high stability with the lapse of time.

What is claimed is:

1. A planographic printing plate precursor comprising:
on a substrate, a photosensitive layer containing an infrared absorbing agent, a sulfonium salt polymerization initiator, a polymerizable compound and a binder polymer,
wherein the central line average surface roughness (Ra) of the surface of the substrate on which the photosensitive layer is arranged is in the range of 0.35 to 0.55 μm.

2. A planographic printing plate precursor according to claim 1, wherein the substrate is an aluminum substrate.

3. A planographic printing plate precursor according to claim 2, wherein the surface of the aluminum substrate is subjected to at least one surface treatment selected from the group consisting of mechanical surface roughening, chemical etching, electrolytic grinding treatment, and electrochemical surface roughening.

4. A planographic printing plate precursor according to claim 1, wherein the binder polymer has a repeating unit represented by the following general formula (i): 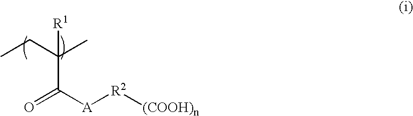
wherein in general formula (i), R¹ represents a hydrogen atom or a methyl group; R² represents a linking group composed of two or more atoms selected from the group consisting of a carbon atom, a hydrogen atom, an oxygen atom, a nitrogen atom and a sulfur atom, wherein the total number of atoms in R² is 2 to 82; A represents an oxygen atom or —NR³— wherein R³ represents a hydrogen atom or a monovalent hydrocarbon group having 1 to 10 carbon atoms; and n is an integer of 1 to 5.

5. A planographic printing plate precursor according to claim 4, wherein the substrate is an aluminum substrate.

6. A planographic printing plate precursor according to claim 5, wherein the surface of the aluminum substrate is subjected to at least one surface treatment selected from the group consisting of mechanical surface roughening, chemical etching, electrolytic grinding treatment, and electrochemical surface roughening.

7. A planographic printing plate precursor comprising:
on a substrate, a photosensitive layer containing an infrared absorbing agent, a sulfonium salt polymerization initiator, a polymerizable compound, and a binder polymer having a repeating unit represented by the following general formula (i), wherein the sulfonium salt polymerization initiator is a sulfonium salt represented by the following general formula (I), and the central line average surface roughness (Ra) of the surface of the substrate on which the photosensitive layer is arranged is in the range of 0.35 to 0.55 μm,
General Formula (i) 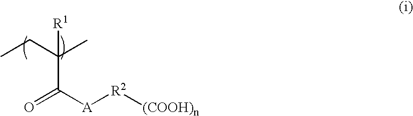
wherein in general formula (i), R¹ represents a hydrogen atom or a methyl group; R² represents a linking group composed of two or more atoms selected from the group consisting of a carbon atom, a hydrogen atom, an oxygen atom, a nitrogen atom and a sulfur atom, wherein the total number of atoms in R² is 2 to 82; A represents an oxygen atom or —NR³—, wherein R³ represents a hydrogen atom or a monovalent hydrocarbon group having 1 to 10 carbon atoms; and n is an integer of 1 to 5;
General Formula (I) 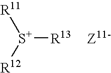
wherein in general formula (I), R¹¹, R¹² and R¹³ may each be the same or different, and each represents a hydrocarbon group having 20 or less carbon atoms which may have at least one substituent group selected from the group consisting of a halogen atom, a nitro group, an alkyl group having 12 or less carbon atoms, an alkoxy group having 12 or less carbon atoms and an aryloxy group having 12 or less carbon atoms; and Z¹¹⁻ represents a counterion selected from the group consisting of a halogen ion, a perchlorate ion, a tetrafluoroborate ion, a hexafluorophosphate ion, a carboxylate ion, and a sulfonate ion.

8. A planographic printing plate precursor according to claim 7, wherein the substrate is an aluminum substrate.

9. A planographic printing plate precursor according to claim 8, wherein the surface of the aluminum substrate is subjected to at least one surface treatment selected from the group consisting of mechanical surface roughening, chemical etching, electrolytic grinding treatment, and electrochemical surface roughening.

10. A planographic printing plate precursor according to claim 7, wherein the photosensitive layer further comprises at least one of iodonium salt represented by the following general formula (II) and diazonium salt represented by the following general formula (III) in addition to the sulfonium salt polymerization initiator;
Ar²¹-I⁺-Ar²²Z²¹⁻ General formula (II)
wherein in general formula (II), Ar²¹ and Ar²² each independently represents an aryl group having 20 or less carbon atoms which may have a substituent group selected from the group consisting of a halogen atom, a nitro group, an alkyl group having 12 or less carbon atoms, an alkoxy group having 12 or less carbon atoms and an aryloxy group having 12 or less carbon atoms; and Z²¹⁻ represents a counterion selected from the group consisting of a halogen ion, a perchlorate ion, a tetrafluoroborate ion, a hexafluorophosphate ion, a carboxylate ion, and a sulfonate ion;
Ar³¹-N⁺≡N Z³¹⁻ General formula (III)
wherein in general formula (III), Ar³¹ represents an aryl group having 20 or less carbon atoms which may have a substituent group selected from the group consisting of a halogen atom, a nitro group, an alkyl group having 12 or less carbon atoms, an alkoxy group having 12 or less carbon atoms, an aryloxy group having 12 or less carbon atoms, an alkylamino group having 12 or less carbon atoms, a dialkylamino group having 12 or less carbon atoms, an arylamino group having 12 or less carbon atoms and a diarylamino group having 12 or less carbon atoms; and Z³¹⁻ represents a counterion selected from the group consisting of a halogen ion, a perchlorate ion, a tetrafluoroborate ion, a hexafluorophosphate ion, a carboxylate ion and a sulfonate ion.

11. A planographic printing plate precursor according to claim 10, wherein the substrate is an aluminum substrate.

12. A planographic printing plate precursor according to claim 11, wherein the surface of the aluminum substrate is subjected to at least one surface treatment selected from the group consisting of mechanical surface roughening, chemical etching, electrolytic grinding treatment, and electrochemical surface roughening.

13. A planographic printing plate precursor comprising:
on a substrate, a photosensitive layer containing an infrared absorbing agent, a sulfonium salt polymerization initiator, a polymerizable compound, and a binder polymer, wherein the binder polymer has a repeating unit represented by the following general formula (i), the polymerizable compound is an addition-polymerizable compound having at least one ethylenically unsaturated double bond, the sulfonium salt polymerization initiator is a sulfonium salt represented by the following general formula (I), and the central line average surface roughness (Ra) of the surface of the substrate on which the photosensitive layer is arranged is in the range of 0.35 to 0.55 μm,
General Formula (i) 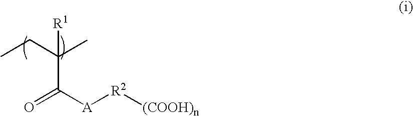
wherein in general formula (i), R¹ represents a hydrogen atom or a methyl group; R² represents a linking group composed of two or more atoms selected from the group consisting of a carbon atom, a hydrogen atom, an oxygen atom, a nitrogen atom and a sulfur atom, wherein the total number of atoms in R² is 2 to 82; A represents an oxygen atom or —NR³— where R³ represents a hydrogen atom or a monovalent hydrocarbon group having 1 to 10 carbon atoms; and n is an integer of 1 to 5;
General Formula (I) 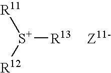
wherein in general formula (I), R¹¹, R¹² and R¹³ may each be the same or different and each represents a hydrocarbon group having 20 or less carbon atoms which may have at least one substituent group selected from the group consisting of a halogen atom, a nitro group, an alkyl group having 12 or less carbon atoms, an alkoxy group having 12 or less carbon atoms and an aryloxy group having 12 or less carbon atoms; and Z¹¹⁻ represents a counterion selected from the group consisting of a halogen ion, a perchlorate ion, a tetrafluoroborate ion, a hexafluorophosphate ion, a carboxylate ion, and a sulfonate ion.

14. A planographic printing plate precursor according to claim 13, wherein the substrate is an aluminum substrate.

15. A planographic printing plate precursor according to claim 14, wherein the surface of the aluminum substrate is subjected to at least one surface treatment selected from the group consisting of mechanical surface roughening, chemical etching, electrolytic grinding treatment, and electrochemical surface roughening.

16. A planographic printing plate precursor according to claim 13, wherein the photosensitive layer further comprises at least one of the iodonium salt represented by the following general formula (II) and the diazonium salt represented by the following general formula (III) in addition to the sulfonium salt polymerization initiator,
Ar²¹-I⁺-Ar²²Z²¹⁻ General formula (II)
wherein in general formula (II), Ar²¹ and Ar²² each independently represents an aryl group having 20 or less carbon atoms which may have a substituent group selected from the group consisting of a halogen atom, a nitro group, an alkyl group having 12 or less carbon atoms, an alkoxy group having 12 or less carbon atoms and an aryloxy group having 12 or less carbon atoms; and Z²¹⁻ represents a counterion selected from the group consisting of a halogen ion, a perchlorate ion, a tetrafluoroborate ion, a hexafluorophosphate ion, a carboxylate ion, and a sulfonate ion;
Ar³¹-N⁺≡N Z³¹⁻ General formula (III)
wherein in general formula (III), Ar³¹ represents an aryl group having 20 or less carbon atoms which may have a substituent group selected from the group consisting of a halogen atom, a nitro group, an alkyl group having 12 or less carbon atoms, an alkoxy group having 12 or less carbon atoms, an aryloxy group having 12 or less carbon atoms, an alkylamino group having 12 or less carbon atoms, a dialkylamino group having 12 or less carbon atoms, an arylamino group having 12 or less carbon atoms and a diarylamino group having 12 or less carbon atoms; and Z³¹⁻ represents a counterion selected from the group consisting of a halogen ion, a perchlorate ion, a tetrafluoroborate ion, a hexafluorophosphate ion, a carboxylate ion, and a sulfonate ion.

17. A planographic printing plate precursor according to claim 16, wherein the substrate is an aluminum substrate.

18. A planographic printing plate precursor according to claim 17, wherein the surface of the aluminum substrate is subjected to at least one surface treatment selected from the group consisting of mechanical surface roughening, chemical etching, electrolytic grinding treatment, and electrochemical surface roughening.
